(19) United States
(12) Patent Application Publication
(10) Pub. No.: US 2019/0130058 A1
(43) Pub. Date: May 2, 2019

(54) U-SPLINES: SPLINES OVER UNSTRUCTURED MESHES

(71) Applicant: Coreform LLC, Orem, UT (US)

(72) Inventor: Derek Thomas, Orem, UT (US)

(21) Appl. No.: 16/012,128

(22) Filed: Jun. 19, 2018

Related U.S. Application Data
(60) Provisional application No. 62/522,621, filed on Jun. 20, 2017.
(60) Provisional application No. 62/621,695, filed on Jan. 25, 2018.
(60) Provisional application No. 62/522,792, filed on Jun. 21, 2017.

(51) Int. Cl. G06F 17/50; G06F 17/17; G06T 17/20

(52) U.S. Cl. CPC G06F 17/5018; G06T 17/20; G06F 17/5095; G06F 17/17

(57) ABSTRACT

U-splines are an improved spline construction for representing smooth objects in Computer-Aided Design (CAD) and Computer-Aided Engineering (CAE). A spline is a piecewise-defined function that satisfies continuity constraints between adjacent elements in a mesh. U-splines differ from existing spline constructions, such as Non-Uniform Rational B-splines (NURBS), subdivision surfaces, T-splines, and hierarchical B-splines, in that they can accommodate local geometrically exact adaptivity in h (element size) t) (polynomial degree), and (smoothness) simultaneously over any mesh topology. U-splines have no restrictions on the placement of T-junctions in the mesh. Mixed element meshes (e.g., triangle and quadrilateral elements in the same surface mesh) are also supported. Additionally, the U-spline basis is positive, forms a partition of unity, is linearly independent, and provides optimal approximation when used in analysis.

### CROSS-REFERENCE TO RELATED APPLICATIONS

This application claims benefit of and priority to U.S. Provisional Patent Application Ser. No. 62/522,621 filed on Jun. 20, 2017 and entitled “U-SPLINES: SPLINES OVER UNSTRUCTURED MESHES OF ARBITRARY DIMENSION,” claims benefit of and priority to U.S. Provisional Patent Application Ser. No. 62/522,792 filed on Jun. 21, 2017 and entitled “U-Splines: Splines Over Unstructured Meshes of Arbitrary Dimension,” and claims benefit of and priority to U.S. Provisional Patent Application Ser. No. 62/621,695 filed on Jan. 25, 2018 and entitled “U-Splines,” each of which applications is expressly incorporated herein by reference in its entirety.

### STATEMENT REGARDING FEDERALLY SPONSORED RESEARCH OR DEVELOPMENT

This invention was made with government support under Award Number DE-5C0017051 awarded by the U.S. Department of Energy, Office of Science, Office of Advanced Scientific Computing Research. Also with support of contract number N6833518C0289 awarded by the United States Naval Air Systems Command. The government has certain rights in the invention.

### BACKGROUND

Splines have commonly been used for representing smooth objects in Computer-Aided Design (CAD) and Computer-Aided Engineering (CAE). A spline is a piecewise-defined function that satisfies continuity constraints between adjacent elements in a mesh. Existing spline constructions, such as Non-Uniform Rational B-splines (NURBS), subdivision surfaces, T-splines, and hierarchical splines, however, cannot accommodate local geometrically exact changes in mesh size, polynomial degree, and continuity simultaneously over any mesh topology. Geometrically exact means that the operation does not change the geometry. This necessitates restrictions on the placement of T-junctions in a mesh. Mixed element meshes (e.g., using both triangle and quadrilateral elements in the same surface mesh) are generally not supported using existing splines.

Continuity refers to the level at which a function shares the same values on either side of an interface. If the function is discontinuous at the interface then the function can have different values at adjacent points in the elements on either side of the interface. A function is said to be value continuous if the function produces the same value at points in each element that are adjacent across the interface. Other levels of continuity are also possible; the slope and curvature of the function can also be continuous across the interface. Higher levels of continuity require mathematical definitions in terms of derivatives. We say a function has continuity of order k where k≥−1; we also say a function is C^{k} continuous. C⁻¹ is discontinuous, C⁰ is value continuous, etc.

There are fundamental limitations with known model representations in CAD and CAE, and there is not a good single representation which is suitable for both CAD and CAE. CAD technologies such as Boundary Repesentations (BREPs), T-splines, subdivision surfaces, and Bézier surfaces are used to represent a design as it matures from industrial design, to mechanical CAD and class A modeling. CAE, on the other hand, uses a faceted mesh representation for simulations and analysis. These mesh representations can represent complex objects in a watertight fashion (i.e., no gaps or holes), an important prerequisite for simulation. The CAE-suitable mesh representations, however, are not suitable for CAD in the sense that they are not smooth, lack higher-order precision, and require far too many shape parameters to be used in most modeling scenarios. The incompatibility between CAD and CAE geometry representations has led to a proliferation of non-value-add data translation techniques, such as mesh generation and model clean-up, which are now required in most commercial CAD-CAE pipelines. Note that finite element analysis (FEA) is the dominant CAE technology today.

CAD technologies such as boundary representations (BREPS), T-splines, and subdivision surfaces represent different approaches to overcoming fundamental limitations in NURBS, which were introduced into CAD in the 1970s. NURBS are restricted to describing objects that have rectangular topology, such as those shown in FIG. 1. FIG. 1 depicts several NURBS models. Various geometric shapes (top row 100) can be created by folding and/or degenerating the parametric domain of the NURBS patch (bottow row 120). However, each geometry is a mapped rectangle. Since nearly every shape of interest in the real world has a non-rectangular topology, enhancements to NURBS were required for commercial applicability.

BREPs, introduced in the 1970s, overcome this rectangular topology limitation of NURBS by combining multiple trimmed NURBS surfaces to form a single model. Trimming curves are used to indicate which portions of the NURBS surface will be rendered and to delineate the boundaries between adjacent NURBS surfaces. A BREP model is shown in FIG. 2. The trimmed model 210 is shown on the left in FIG. 2 while the untrimmed model 220 is shown on the right in FIG. 2. The flexibility afforded by trimming curves has made BREPs the standard in mechanical CAD.

Unfortunately, BREP models also suffer from a very serious mathematical limitation: they are rarely watertight due to the mathematical properties of the surface intersection problem. Exact representation of intersection curves, when possible, requires unreasonably high degree polynomials and is limited by floating point implementations. An example intersection in a simple BREP model is shown in FIG. 3. Here, a teapot and spout are joined through a surface intersection operation: a trimming curve is placed on both the pot and spout and then they are joined. Visually, it appears that the resulting model 310 is watertight, but upon closer inspection it is clear that there are gaps 320 between the pot and spout. The gaps, overlaps, and sliver surfaces that are common to BREP geometry are often called dirty geometry, since they negatively impact all downstream applications of the geometry. For example, in simulation, it is preferable to have a watertight representation of geometry. This means that all dirty geometry must be repaired before it can be used. Since the gaps and overlaps in a BREP result from rigid theoretical deficiencies in the representation, the entire BREP model is usually replaced with a mesh, which represents a faceted approximation to the original BREP geometry which can then be used during simulation. The process of generating a mesh from a BREP geometry is very often tedious, manual, time-consuming, expensive, and error-prone.

A number of industries have moved or are beginning to move beyond the aging BREP standard, preferring to use so-called “watertight CAD” technologies such as subdivision surfaces or T-splines, which excel when aesthetics, advanced manufacturing, generative modeling, or interoperability are primary concerns. For example, many global automakers now first define all visible interior and exterior surfaces of a car in watertight CAD until they are remodeled as Bézier surfaces for class A modeling and pushed into CAD for engineering. Subdivision surface technology, especially Catmull-Clark subdivision surfaces, are popular in the animation industry where the mathematical precision of NURBS is less important than in other industries. For animation applications, subdivision surfaces are particularly straightforward to shape into complex organic shapes. Pixar has developed a widely used subdivision surface technology called OpenSubds, and has made it open source to encourage standardization in the animation industry. T-splines are a generalization of NURBS and subdivision surfaces, and can now be found in several major CAD products. T-splines are distinct from subdivision surfaces in that they allow local element subdivision (also called local refinement).

It is not always appreciated that the philosophy underlying the representation of information employed in CAD representations such as NURBS, T-splines, or subdivision surfaces is similar to that employed in CAE. Both fields need to represent continuous fields using discrete points. Both have adopted a basis-centric approach in which control points (CAD) or nodal values (CAE) are associated with a unique basis function. The shape or solution at any point is constructed by multiplying each basis function defined at that point by the associated data and summing the result. In CAD, this would be written as:

$$x ( s , t ) = {\sum }_{A} {P}_{A} {B}_{A} ( s , t ) \qquad ( 1 )$$

where the shape of the surface x(s, t) is given by a sum of the control points P_{A} multiplied by the spline basis functions B_{A}(s, t). In FEA, the same idea is expressed in a similar form:

$$u = {\sum }_{A} {d}_{A} {N}_{A} \qquad ( 2 )$$

where in this case the solution u is given by the sum of the product of the nodal values d_{A} and the shape functions NA. It is clear that the most significant difference between the two representations is the terminology or notation and the basis (splines vs shape functions). Commercial CAD applications typically choose splines as a basis due to the need for smooth surfaces. There are many types of finite-element shape functions, but the most common simply perform linear interpolation of the nodal values. This is actually the simplest form of a spline. However, these functions are rarely used in design due to the faceted quality of the surfaces they produce and the number of points required to represent a complex shape. In both fields, the quality of the result is directly connected to the quality of the basis.

In isogeometric analysis (IGA), analysis-suitable CAD representations are used directly in CAE simulations. IGA has demonstrated that dramatic benefits can be gained in CAE by moving from traditional faceted mesh representations to so-called analysis-suitable CAD descriptions. Not only can the CAD/CAE data translation problem be eliminated, but by adopting smooth spline basis functions, dramatic gains can be achieved in accuracy, robustness, and efficiency across a wide spectrum of application domains.

Research in the field of analysis-suitable CAD has grown exponentially in recent years, with the goal of identifying a single representation suitable for CAD and CAE. To date, virtually all existing and prior CAD descriptions have been investigated as a basis for IGA, including BREPs, subdivision surfaces, and T-splines. T-splines emerged as the state-of-the-art CAD representation for IGA, but still suffer from significant limitations that have prevented their commercial use in the isogeometric paradigm. For example, commercial T-spline implementations are restricted to degree three, and in general, different algorithms are required for the even, odd, and mixed degree cases. Locally changing the degree of T-spline faces is not possible. For T-spline blending functions to have the appropriate mathematical properties for simulation such as linear independence, partition of unity, polynomial completeness and positivity, rigid topological constraints must be imposed on a T-spline control mesh. There is also no clear path to analysis-suitable T-spline volumes.

A set of functions is said to possess a partition of unity if at each point in the domain of the functions, the sum of all functions in the set at that point is equal to one. This is often abbreviated as

$${\sum }_{A} {N}_{A} = 1. \qquad ( 3 )$$

A set of functions is said to be positive (more accurately nonnegative) if none of the functions evaluate to a value less than 0. These two properties have important implications in both design and analysis. A set of functions is said to be complete if any function in a well-defined class can be represented by a combination of the functions in the set. These classes are referred to as function spaces. Common function spaces include polynomials and piecewise polynomials. A function set is complete with respect to the polynomials of a given degree if any polynomial of that degree can be represented in terms of the functions in the set.

### BRIEF SUMMARY

U-splines are a novel spline construction for representing smooth objects in both Computer-Aided Design (CAD) and Computer-Aided Engineering (CAE). A spline is a piecewise-defined function that satisfies continuity constraints between adjacent elements in a mesh. U-splines differ from existing spline constructions, such as Non-Uniform Rational B-splines (NURBS), subdivision surfaces, T-splines, and hierarchical splines, in that they can accommodate local geometrically exact changes in mesh size, polynomial degree, and continuity simultaneously over any mesh topology. Geometrically exact means that the operation does not change the geometry. As a result, unlike prior spline constructions, U-splines impose no restrictions on the placement of T-junctions in the mesh. Mixed element meshes (e.g., triangle and quadrilateral elements in the same surface mesh) are also supported. Additionally, the U-spline basis is nonnegative, forms a partition of unity, is linearly independent, and provides optimal approximation when used in analysis.

Commercial CAD and CAE implementations of U-splines can enable an isogeometric analysis (IGA) workflow that may significantly reduce the hundreds of millions of dollars wasted annually in translating data between CAD and CAE representations in aerospace, automotive, defense, and other industries. The unique U-splines basis construction process generates the minimal number of control points or degrees of freedom required for a given application. As depicted in FIG. 4, an isogeometric CAD-CAE approach will enable more accurate and robust simulation and better integration between CAD and CAE. For example, in automotive crash simulation, today's FEA process takes millions of dollars and many weeks to prepare a model for simulation, time that would be nearly eliminated by an isogeometric approach. FIG. 4, on the left, shows the disconnected and inefficient nature of previous CAD-CAE processes 410, and, on the right, shows an improved, isogeometric approach 420. A schematic illustrating an isogeometric CAD-CAE workflow is shown on the right of FIG. 4. This may also offer unique benefits for emerging applications like topology optimization, generative design, and additive manufacturing.

The construction process of U-splines is inverted from that of other spline technologies. In NURBS or T-spline constructions, a control mesh is first specified, which defines the position of control points, their connectivity, and the topological relationship between blending functions. Parametric lengths called knot intervals are assigned to each edge of the control mesh, and a global parametric degree for the basis is specified. An algorithm is then executed that generates a set of B-spline blending functions from the topology, degree, and knot intervals of the control mesh. In the case of T-splines, this algorithm can result in a proliferation of blending functions with no clear mathematical significance. Finally, a computational mesh can be extracted from the spline, for use as the finite element mesh in IGA or other mesh processing algorithms.

To construct a U-spline, the process is flipped. First, a computational mesh is defined that specifies the degree of each face and the knot interval ratios and smoothness of each edge. An algorithm is then executed that builds a basis directly from the computational mesh by enforcing the smoothness constraints on the coefficients of each face in the mesh. As a result of this tight coupling between the basis function construction algorithm and the computational mesh, no extraneous basis functions are generated. Finally, the control mesh is extracted.

An innovation underlying U-splines is an algorithm that solves a series of highly localized nullspace problems of size bounded by the local characteristics of the basis chosen for each element, the local mesh topology, and the associated smoothness constraints. Each local nullspace problem is solved to determine exactly one spline basis function. The U-spline algorithm guarantees that each U-spline basis function is nonnegative and that the resulting basis satisfies a partition of unity. The algorithm is expressed entirely in terms of integers and requires no floating point operations until the indices of the nonzero coefficients of a U-spline basis function have been determined. A novel indexing scheme is used to uniquely identify each U-spline basis function in the mesh and to construct the associated control mesh. The only requirement for an initialization of the algorithm is that a Bernstein-like basis be defined over each element in an initial mesh. A mixture of standard polynomial Bernstein bases over cuboidal and simplicial (triangular and tetrahedral) elements can be used in addition to more exotic Bernstein-like bases based on exponential, trigonometric, and other special functions.

The U-spline approach can be contrasted with traditional approaches to spline construction that either enforce restrictive global or semi-local mesh topology constraints (e.g., NURBS and T-splines) to simplify the process of determining blending functions, or attempt to find a spline basis by determining the solution to a global nullspace problem assembled from all the continuity constraints defined over an entire mesh. Solving for a spline basis directly through a global nullspace problem is theoretically attractive since the solution is the sparsest set of positive, linearly independent vectors that span the nullspace of the continuity constraint system, where sparse means each vector has the minimum number of nonzero entries. The coefficients in each vector uniquely define a single spline basis function directly. Unfortunately, finding the solution to a general nullspace problem is NP-hard and is further complicated by errors introduced through floating point arithmetic. U-splines avoid these difficulties by incrementally determining a basis through a series of local nullspace problems which can be determined by operations on the indices of the local Bernstein basis assigned to each element.

A motivation for U-splines can be traced to the fundamental model representation limitations in CAD and CAE, and the aspiration to identify a single representation that is suitable for both CAD and CAE. CAD technologies such as BREPs, T-splines, subdivision surfaces, and Bézier surfaces are used to represent a design as it matures from industrial design, to mechanical CAD and class A modeling. CAE, on the other hand, uses a faceted mesh representation for simulations. These mesh representations can represent complex objects in a watertight fashion (i.e., no gaps or holes), an important prerequisite for simulation, but they are not suitable for CAD in the sense that they are not smooth, lack higher-order precision, and require far too many parameters to capture shape to be used in most modeling scenarios. The incompatibility between CAD and CAE geometry representations has led to a proliferation of non-value-add data translation techniques, such as mesh generation and model clean-up, which are now required in most commercial CAD-CAE pipelines. U-splines provides the substantial benefit of providing a single representation that is suitable for both CAD and CAE.

Table 1 summarizes the analysis-suitability of previous CAD descriptions as well as U-splines. In contrast to other analysis-suitable geometry candidates, U-splines were invented specifically to satisfy the requirements of analysis-suitability. As articulated in Table 1, U-splines possess all the required attributes. Compared directly with the prior state-of-the-art, T-splines, U-splines are superior in that they can accommodate arbitrary degree and local exact changes in h (element subdivision), p (degree), and k (smoothness), guarantee linear independence, provide optimal approximation, and offer a straightforward path to analysis-suitable volumetric representations.

TABLE 1
A comparison of the analysis-suitability of U-splines,
BREPs, T-splines, subdivision, and FEA meshes.

| | U- | | T- | | FEA |
|---|---|---|---|---|---|
| Property | splines | BREPs | Splines | Subds | Mesh |
| NURBS compatibility | Yes | Yes | Yes | No | No |
| Exact Geometry | Yes | Yes | Yes | Yes | No |
| No dirty geometry | Yes | No | Yes | Yes | No |
| Smooth basis | Yes | Yes | Yes | Yes | No |
| Arbitrary degree | Yes | Yes | No | No | Yes |
| Local exact h, p, k | Yes | No | No | No | No |
| adaptivity | | | | | |
| Watertight | Yes | No | Yes | Yes | Yes |
| Linear independence | Yes | Yes | No | No | Yes |
| Optimal approximation | Yes | No | No | No | Yes |
| Volumes | Yes | No | No | No | Yes |

### BRIEF DESCRIPTION OF THE DRAWINGS

In order to describe the manner in which advantages and features described herein can be implemented and obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates geometric shapes that can be created by folding and/or degenerating the parametric domain of a NURBS patch.

FIG. 2 illustrates a BREP automotive B-pillar model and its untrimmed counter-part.

FIG. 3 illustrates a BREP intersection operation to join a pot and spout which results in gaps and overlaps in the final BREP model.

FIG. 4 compares a finite element analysis (FEA) process with an isogeometric approach.

FIG. 5 illustrates subdivision of a pyramid into two tetrahedra.

FIG. 6 illustrates a univariate cubic Bernstein basis and indexing.

FIG. 7 illustrates a Bernstein index and a simplified representation.

FIG. 8 illustrates an example of element index distances.

FIG. 9 illustrates a single element index block.

FIG. 10 illustrates coefficients that may participate in a constraint.

FIG. 11 illustrates an example application of constraints for nonmatching tensor-product elements.

FIG. 12 illustrates an example of indexing used to define simplicial continuity constraints.

FIG. 13 illustrates regions used to define constraints between simplicial and cuboidal elements.

FIG. 14 illustrates plots of B-spline basis function coefficient values and corresponding spline basis functions.

FIG. 15 illustrates constrained index blocks which can be defined on two elements of degree 3.

FIG. 16 illustrates an expansion of a constrained index block across an interface.

FIG. 17 illustrates two possible orientations of two elements sharing a matching interface.

FIG. 18 illustrates adjacent element index blocks on adjacent matching elements.

FIG. 19 illustrates index blocks computed to maintain compatibility across an interface.

FIG. 20 illustrates adjacent element index blocks on adjacent elements having different polynomial degree.

FIG. 21 illustrates compatible index blocks across an interface where the adjacent elements are of different type.

FIG. 22 illustrates steps to produce a constrained index block in the neighborhood of a system of T-junctions.

FIG. 23 illustrates a univariate mesh consisting of 4 elements with a basis of polynomial degree 3 on each element.

FIG. 24 illustrates examples of constrained index blocks used to construct function index supports in a multivariate setting.

FIG. 25 illustrates a flowchart of a method for producing U-splines.

FIG. 26 illustrates steps for determining function index support for a function.

FIG. 27 illustrates an example of a basis constructed over a mesh of mixed degree.

FIG. 28 illustrates indices of coefficients constrained by interfaces in a T-junction.

FIG. 29 illustrates examples of constrained index blocks for two elements of different polynomial degrees and latent constrained index blocks.

FIG. 30 illustrates an example of constrained index blocks computed for a function over elements containing adjacent perpendicular T-junctions.

FIG. 31 illustrates an example of constrained index blocks computed for a function over elements containing adjacent perpendicular continuity transitions.

FIG. 32 illustrates an example of a cubic function built from an index.

FIG. 33 illustrates an example U-spline basis function and corresponding three-dimensional plot.

FIG. 34 illustrates an example U-spline basis function from a Bézier mesh containing nested T-junctions and corresponding three-dimensional plot.

FIG. 35 illustrates an example basis function from a mesh of degree 2 containing nested T-junctions and corresponding three-dimensional plot.

FIG. 36 illustrates an example basis function from a mesh of degree 3 containing nested T-junctions and corresponding three-dimensional plot.

FIG. 37 illustrates an example of a basis function defined over a mesh of mixed polynomial degree and corresponding three-dimensional plot.

FIG. 38 illustrates an example of a basis function defined over a mesh of mixed polynomial degree and corresponding three-dimensional plot

FIG. 39 illustrates an example basis function from a mesh having both triangular and quadrilateral elements.

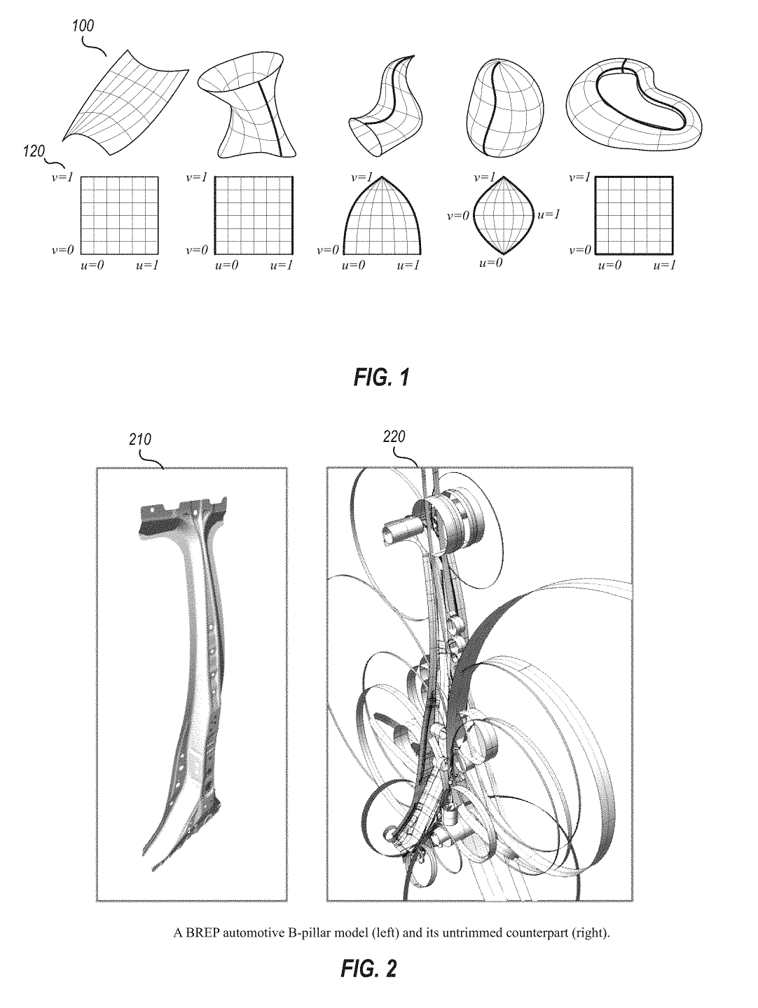

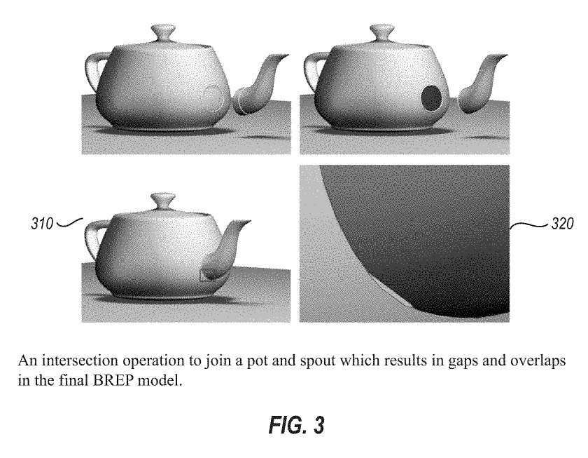

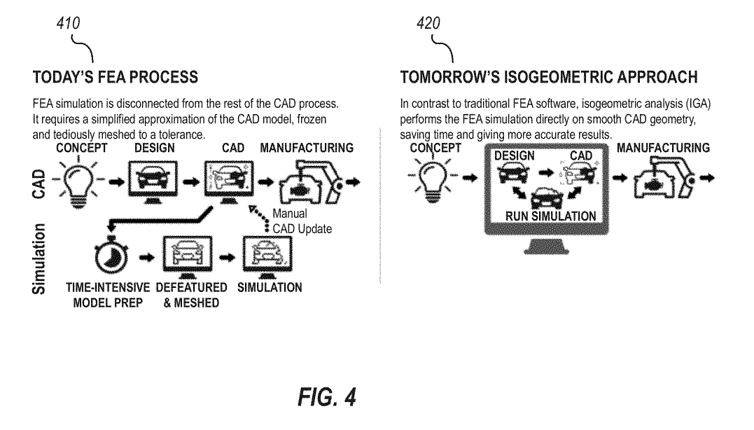

### DETAILED DESCRIPTION

### 6.1 Introduction

U-splines are a novel spline construction for representing smooth objects in both Computer-Aided Design (CAD) and Computer-Aided Engineering (CAE). A spline is a piecewise-defined function that satisfies continuity constraints between adjacent elements in a mesh. U-splines differ from existing spline constructions, such as Non-Uniform Rational B-splines (NURBS), subdivision surfaces, and T-splines, in that they can accommodate local geometrically exact modifications of element size, polynomial degree, and smoothness simultaneously over any mesh topology. Geometrically exact means that the operation does not change the geometry. As a result, there are no restrictions on the placement of T-junctions in the mesh. Mixed element meshes (e.g., triangle and quadrilateral elements in the same surface mesh) are also supported. Additionally, the U-spline basis is positive, forms a partition of unity, is linearly independent, and provides optimal approximation when used in analysis.

An innovation underlying U-splines is a method for solving a series of highly localized nullspace problems of size bounded by the local characteristics of the basis chosen for each element, the local mesh topology, and the associated smoothness constraints. Each local nullspace problem is solved to determine exactly one spline basis function. The U-spline algorithm guarantees that each U-spline basis function is positive and that the resulting basis satisfies a partition of unity. The algorithm is expressed entirely in terms of integers and requires no floating point operations until the indices of the nonzero coefficients of a U-spline basis function have been determined. A novel indexing scheme is used to uniquely identify each U-spline basis function in the mesh and to construct the associated control mesh. The only requirement for the initialization of the algorithm is that a Bernstein-like basis be defined over each element in the mesh. A mixture of standard polynomial Bernstein bases over cuboidal and simplicial (triangular) elements can be used in addition to more exotic Bernstein-like bases based on exponential, trigonometric, and other special functions.

The use of U-splines in commercial CAD and CAE implementations can improve the quality and flexibility of shape representation, the accuracy, robustness, and efficiency of simulation, and create fully integrated isogeometric analysis (IGA) workflows that may significantly reduce the hundreds of millions of dollars and significant time wasted annually in translating data between CAD and CAE representations in aerospace, automotive, defense, and other industries. The unique U-spline basis construction process generates the minimal number of control points or degrees of freedom required for a given application. This may also offer unique benefits for emerging applications like topology optimization, generative design, and additive manufacturing.

A detailed description of the process for computing and constructing U-splines is given below.

### 6.2 Bernstein Representations

6.2.1 Polynomial Basis

The univariate Bernstein basis is defined as

$${B}_{i}^{p} ( s ) = ( \begin{matrix}p \\ i\end{matrix} ) {{s}^{i} ( 1 - s )}^{p - i} , \qquad ( 4 )$$

where p is the polynomial degree, s∈[0, 1], and the binomial coefficient is

$$( \begin{matrix}p \\ i\end{matrix} ) = \frac{p !}{( i ) ! ( p - i ) !} ,$$

0≤i≤p. The Bernstein basis possesses many remarkable properties but the primary property of interest for this work is the ordering of the derivatives of the basis functions. A function ƒ: [symbol] → [symbol] vanishes n times at a real value a if ƒ (a)=0 and ƒ⁽ⁱ⁾(a)=0 for all i∈[0,n]. The IP) ith Bernstein basis function Bf on the interval [0, 1] vanishes i times at 0 and p−i times at 1. This property can be observed in Table 2 where the evaluations of the Bernstein basis and its derivatives are shown at the endpoints of the interval [0, 1].

Two constructions for the multivariate setting are employed. One construction is the tensor-product of multiple univariate Bernstein bases:

$${B}_{i}^{p} ( s ) = {\prod }_{j = 0}^{d} {B}_{{i}_{j}}^{{p}_{j}} ( {s}_{j} ) . \qquad ( 5 )$$

This is defined over box-like elements. In this work, bold-face symbols are used to represent tuples, vectors and matrices. The associated italic symbol with subscripts may be used to refer to individual components: the symbol i represents an index tuple, iⱼ refers to the jth entry in

TABLE 2
$Derivatives of Bernstein polynominal \frac{{d}^{n}}{{ds}^{n}} {B}_{i}^{p} ( s ) evaluated at the$
endpoints of the interval.

| | | | i = 0 | i = 1 | i = 2 | i = 3 |
|---|---|---|---|---|---|---|
| p = 1 | n = 0 | s = 0 | 1 | 0 | — | — |
| | | s = 1 | 0 | 1 | — | — |
| | n = 1 | s = 0 | −1 | 1 | — | — |
| | | s = 1 | −1 | 1 | — | — |
| p = 2 | n = 0 | s = 0 | 1 | 0 | 0 | — |
| | | s = 1 | 0 | 0 | 1 | — |
| | n = 1 | s = 0 | −2 | 2 | 0 | — |
| | | s = 1 | 0 | −2 | 2 | — |
| | n = 2 | s = 0 | 2 | −4 | 2 | — |
| | | s = 1 | 2 | −4 | 2 | — |
| p = 3 | n = 0 | s = 0 | 1 | 0 | 0 | 0 |
| | | s = 1 | 0 | 0 | 0 | 1 |
| | n = 1 | s = 0 | −3 | 3 | 0 | 0 |
| | | s = 1 | 0 | 0 | −3 | 3 |
| | n = 2 | s = 0 | 6 | −12 | 6 | 0 |
| | | s = 1 | 0 | 6 | −12 | 6 |
| | n = 3 | s = 0 | −6 | 18 | −18 | 6 |
| | | s = 1 | −6 | 18 | 18 | 6 |

the tuple. For complex objects, square brackets followed by subscripts may be used to refer to components: [i]ⱼ=iⱼ.

For example, the tensor-product Bernstein function with index i=(1,2), degree p=(3, 2) is defined as

B_{(1,2)}^{(3,2)}(s,t)=B₁³(s)B₂²(t) (6)

The other construction is the multivariate Bernstein polynomial basis defined over simplicial elements. For a simplex of dimension d, the basis of degree p is defined in terms of the barycentric coordinates λᵢ, i∈[0, d] and an index tuple a of size d+1 of positive integers whose sum is equal to p. The α-th basis function is given by

$${B}_{α}^{p} ( λ ) = p ! {\prod }_{i = 0}^{d} \frac{{λ}_{i}^{{α}_{i}}}{{α}_{i} !} . \qquad ( 7 )$$

For example, the two dimensional Bernstein polynomial of degree p=6 with index α=(1,2,3) is given by

$$\begin{matrix}{B}_{( 1 , 2 , 3 )}^{3} ( {λ}_{0} , {λ}_{1} , {λ}_{2} ) = 6 ! \frac{{( {λ}_{0} )}^{1}}{1 !} \frac{{( {λ}_{1} )}^{2}}{2 !} \frac{{( {λ}_{2} )}^{3}}{3 !} \\ = 60 {{λ}_{0} ( {λ}_{1} )}^{2} {( 1 - {λ}_{0} - {λ}_{1} )}^{3} .\end{matrix} \qquad ( 8 )$$

The multivariate Bernstein basis functions possess similar ordering properties to the univariate basis. Additionally, for each boundary of the simplex, the nonzero entries in the basis are precisely the basis for the simplex of dimension d−1.

6.2.2 Bernstein-Like Basis

Although the focus is primarily on the polynomial Bernstein basis in this work, this is not a necessary requirement. Mazure proved that quasi extended Chebyshev (QEC) spaces possess a Bernstein-like basis with the following property: Let ε be an (n+1)-dimensional QEC-space on the bounded closed interval [a, b]. Then, ε possesses a quasi Bernstein-like basis relative to (a, b), that is, a basis B₀, . . . , Bₙ, such that:
B₀(a)≠0, and B₀ vanishes n times at b; Bₙ(b)≠0, and Bₙ vanishes n times at a;
for 1≤i≤n−1, Bᵢ vanishes exactly i times at a and exactly (n−i) times at b.
for 0≤i≤n, Bᵢ is positive on]a, b[.

This property is the key requirement for the U-spline definition and construction and so U-splines can be constructed from meshes with a QEC space assigned to each element.

6.2.3 Change of Basis

The Bernstein representation admits many closed-form expressions for the change of basis. Here several relations for Bernstein polynomials are given. Similar results can be obtained for other Bernstein-like bases or computed directly.

The coefficients b of a Bernstein polynomial of degree p may be converted to coefficients b̅ of a Bernstein polynomial of degree p−r by multiplication by a matrix:

b̅=E^{p,r}b (9)

where the nonzero entries of the matrix are given by

$${E}_{ij}^{p , r} = \frac{( \begin{matrix}r \\ i - j\end{matrix} ) ( \begin{matrix}p \\ j\end{matrix} )}{( \begin{matrix}p + r \\ i\end{matrix} )} , max ( 0 , i - r ) \leq j \leq min ( p , i ) \qquad ( 10 )$$

Similarly, the coefficients b̅ of the Bernstein basis over some interval (s₀, s₁) can be obtained from the coefficients b of the Bernstein basis over the standard unit interval by matrix multiplication:

b̅=R^{s}^{₀}^{,s}^{₁}b (11)

where the nonzero entries of the matrix are

$${R}_{jk}^{{s}_{0} , {s}_{1}} = {\sum }_{i = max ( 0 , j + k - p )}^{min ( j , k )} {B}_{k - i}^{p - j} ( {s}_{0} ) {B}_{i}^{j} ( {s}_{1} ) , j \leq n , 0 \leq k . \qquad ( 12 )$$

### 6.3 the Bézier Mesh

6.3.1 Topology and Parameterization

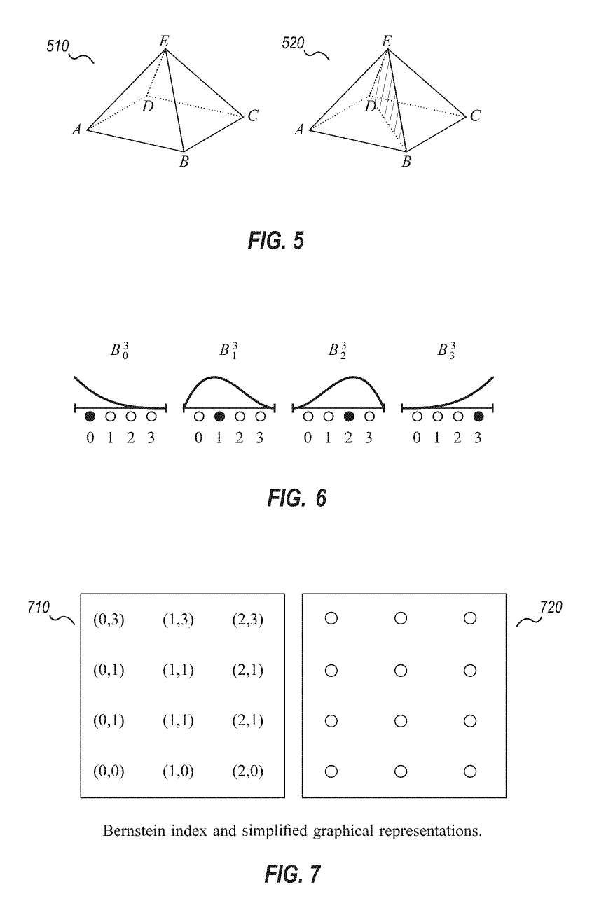

Unstructured splines, or U-splines, can be defined over unstructured meshes constructed entirely of elements that permit either tensor-product or simplicial parameterization. T-junctions are allowed to occur in the mesh. Each element is assigned a local parametric coordinate system. This system is assumed to be Cartesian on box-like elements and the parametric coordinates are denoted by either s, t, u or sᵢ. Barycentric coordinates are employed on simplicial elements and the symbols λᵢ are used. It should be noted that for three-dimensional meshes this approach permits pentahedral prisms produced by a tensor product of a triangle with a line but does not permit pyramid elements. However, any pyramid element can be replaced by two tetrahedra. This is illustrated in FIG. 5 wherein a pyramid 510 is subdivided into two tetrahedra 520. FIG. 5 depicts subdivision of the pyramid with base ABCD and elevated point E to produce two tetrahedra ABDE and BCDE.

Each element is also assigned parametric dimensions. The most general description possible for the parametric size of each element is adopted. Each element/edge pair in the mesh is assigned a parametric length. The parametric dimensions of the boundary of an element must be consistent. For a box-like element, this means that opposite faces must have the same size in the local parameterization of the element. Adjacent elements must also satisfy a cycle condition: for each vertex in the mesh, the product of the ratios of adjacent edge lengths on a subset of the edges emanating from the vertex traversed in a oriented closed loop must be equal to one. This corresponds to fixing a seamless similarity map between adjacent elements. This approach was first introduced for T-splines over conformal seamless similarity maps by Campen and Zorin.

6.3.2 Element Basis and Interelement Continuity

Each element in the mesh is assigned a basis. The symbol e is used to denote an element index. For polynomial splines, this amounts to assigning a polynomial degree p^{e} to each simplicial element and a tuple of polynomial degrees p^{e} to each tensor-product element (one for each parametric direction). If more general Bernstein-like bases are to be employed then these must be assigned to each element. The symbol B^{e} is used to denote the set of Bernstein basis functions assigned to an element e. The set of all Bernstein functions over all the elements in a mesh M is denoted by B^{M}.

Each interface between elements in the mesh is also assigned a required minimum continuity that represents the minimum number of derivatives that are continuous perpendicular to the interface. Given an interface I, let k(I) represent the minimum order of continuity of the interface. Note that for certain mesh configurations, the U-spline basis may be smoother than the specified continuity conditions.

6.3.3 Element Basis Indexing

Once an element in the mesh has been assigned a Bernstein-like basis, the individual basis functions on each element can be uniquely identified in order to impose the required continuity constraints.

The Bernstein basis admits a natural indexing. This indexing is most naturally expressed in terms of the tuples used in the definition of the polynomial Bernstein basis. A similar indexing exists for Bernstein-like bases of QEC spaces.

A univariate Bernstein basis is indexed by one number, a tensor-product Bernstein basis is indexed by a tuple of size d (one number for each direction), and a simplex is indexed by a tuple of size d+1. This is called the Bernstein index. The index set of the Bernstein basis set B is denoted by I(B).

For example, if the set of Bernstein basis functions is the univariate cubic Bernstein polynomials,

B={B₀³,B₁³,B₂³,B₃³}, (13)

then the index set is

I(B)={0,1,2,3}. (14)

This basis is shown in FIG. 6. FIG. 6 depicts a univariate cubic Bernstein basis shown with the adopted indexing convention and corresponding circular markers. Indices corresponding to nonzero coefficient values of the basis are indicated with filled markers. The indexing is shown beneath the plot with the marker corresponding to the plotted function being filled. In most diagrams that follow, the numeric indices are suppressed and dots are used to indicate the degree of the basis employed. Indices corresponding to nonzero coefficients are filled.

If the set of Bernstein basis functions is the tensor-product Bernstein polynomials of mixed degree p=(1, 2),

B={B_{(0,0)}^{(1,2)},B_{(1,0)}^{(1,2)},B_{(0,1)}^{(1,2)},B_{(1,1)}^{(1,2)},B_{(0,2)}^{(1,2)},B_{(1,2)}^{(1,2)}}, (15)

then the index set is

I(B)={(0,0),(1,0),(0,1),(1,1),(0,2),(1,2)}. (16)

The indices can be used as coordinates and markers placed at each of the corresponding locations in the element can be used to indicate the number of basis functions on each element. This is shown for a basis with polynomial degrees p=(2, 3). Rather than including explicit numeric values for the indices, markers can be used. Both numeric values 710 and the corresponding markers 720 are shown in FIG. 7.

If the set of Bernstein basis functions is the bivariate simplicial Bernstein polynomials of degree p=2,

B={B_{(0,0,2)}²,B_{(1,0,1)}²,B_{(2,0,0)}²,B_{(0,1,1)}²,B_{(0,2,0)}²,B_{(1,1,0)}²} (17)

then the index set is

I(B)={(0,0,2),(1,0,1),(2,0,0),(0,1,1),(0,2,0),(1,1,0)}. (18)

If the basis used on each element has been specified, each function can be uniquely identified by the element index and the local Bernstein index. The element and Bernstein indices can be combined to produce a global Bernstein index (e, i). This unambiguously identifies the Bernstein basis function B_{e,i}. The polynomial degree p can vary from element to element and so is omitted. Index sets over a specific element or sets of elements are assumed to include the element and local Bernstein indices; e.g., for the basis B^{e} associated with element e, having polynomial degree p^{e}=(1, 2), the index set is

I(B^{e})={(e,(0,0)),(e,(1,0)),(e,(0,1)),(e,(1,1)),(e,(0,2)),(e,(1,2))}. (19)

For two bilinear elements, e and e′, the index set is

I(B^{e}∪B^{e′})={(e,(0,0)),(e,(1,0)),(e,(0,1)),(e,(1,1)),(e′,(0,0)),(e′,(1,0)),(e′,(0,1)),(e′,(1,1))}. (20)

When the meaning is clear from the context, the explicit element index will be suppressed and bold symbols will be used instead to refer to global indices containing both element index and the local Bernstein index.

6.3.4 Element Index Distances

The Bernstein indices on an element form a discrete finite-dimensional space. It is useful to define the difference vector:

δ(i,j)=j−i (21)

and the distance vector d whose entries are the absolute value of the entries of the difference vector:

dₖ(iₖ,jₖ)=|δ(iₖ,jₖ)|. (22)

A function that provides the distances between an index and the element boundaries is needed. To indicate direction the parametric index and the sign in the associated direction dᵢ^{±} can be specified. For tensor-product elements,

$${d}_{j}^{σ} ( i ) = \{ \begin{matrix}{p}_{j} - {i}_{j} , & σ = + \\ {i}_{j} , & σ = -\end{matrix} \qquad ( 23 )$$

where p=(p₀, . . . ,p_{d-1}) represents the polynomial degree (or one less than the total number of Bernstein basis functions in the corresponding dimension for Bernstein-like bases).

For example, consider a tensor product element of degree p=(2, 3) and a Bernstein index i=(1,3). The output of the distance function is:

d₀⁺((1,3))=1

d₁⁺((1,3))=0

d₀⁻((1,3))=1

d₀⁻((1,3))=3

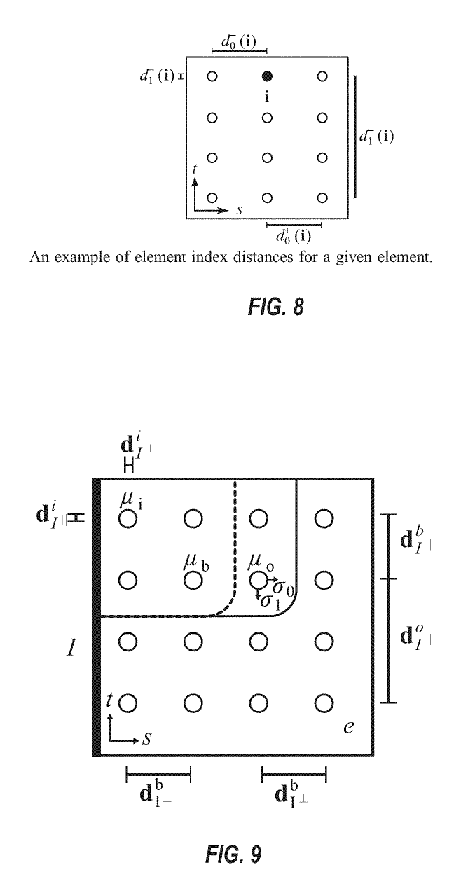

This set of distances is illustrated in FIG. 8.

The distance to a specified boundary within an element can also be determined. For an element e bounded by an interface I the distance from the index i in element e to the boundary I is denoted by d_{I}(i).

6.3.5 Element Index Blocks

An element index block is a set of element indices grouped into an oriented block. To specify a block of indices on an element e an orientation σ is required that indicates the outward orientation of the block in each parametric direction, the inner index value μᵢ, and the barrier and outer index values (μ_{b} and μₒ, respectively) in each parametric direction. The symbol β is used to represent an element index block. The various properties are indicated by subscript or superscript:

β_{μ}_{ᵢ}_{,μ}_{_{b}}_{,μ}_{ₒ}^{e,σ}. (24)

In situations where not all data is required, the sub- and superscripts are omitted to simplify presentation.

The distance operators for the element index block relative to an interface I must be defined in the parametric direction(s) perpendicular to the interface and in the direction(s) parallel to the interface. The direction in which the distance is measured depends on whether the inner, barrier, or outer index bounds is of interest. The relevant bound is indicated by a superscript. The distances of the inner and barrier bounds are always measured opposite the outward orientation while the outer bound is always measured in the direction of the outward orientation. Let I(I^{∥}) represent the set of element indices parallel to the interface I. Then the the inward distances are given by

$$\begin{matrix}{[ {d}_{{I}^{⊥}}^{a} ( {β}_{{μ}_{i} , {μ}_{b} , {μ}_{o}}^{e , σ} ) ]}_{j} = \{ \begin{matrix}{μ}_{a , j} , & {σ}_{j} = + \\ {p}_{j} - {μ}_{a , j} , & {σ}_{j} = -\end{matrix} , j ∉ I ( {I}^{‖} ) , a ∈ \{ i , b \} & ( 25 ) \\ {[ {d}_{{I}^{‖}}^{a} ( {β}_{{μ}_{i} , {μ}_{b} , {μ}_{o}}^{e , σ} ) ]}_{j} = \{ \begin{matrix}{μ}_{a , j} , & {σ}_{j} = + \\ {p}_{j} - {μ}_{a , j} , & {σ}_{j} = -\end{matrix} , j ∈ I ( {I}^{‖} ) , a ∈ \{ i , b \} & ( 26 )\end{matrix}$$

and the outward distances by

$$\begin{matrix}{[ {d}_{{I}^{⊥}}^{o} ( {β}_{{μ}_{i} , {μ}_{b} , {μ}_{o}}^{e , σ} ) ]}_{j} = \{ \begin{matrix}{p}_{j} - {μ}_{o , j} , & {σ}_{j} = + \\ {μ}_{o , j} , & {σ}_{j} = -\end{matrix} , j ∉ I ( {I}^{‖} ) & ( 27 ) \\ {[ {d}_{{I}^{‖}}^{o} ( {β}_{{μ}_{i} , {μ}_{b} , {μ}_{o}}^{e , σ} ) ]}_{j} = \{ \begin{matrix}{p}_{j} - {μ}_{o , j} , & {σ}_{j} = + \\ {μ}_{o , j} , & {σ}_{j} = -\end{matrix} , j ∈ I ( {I}^{‖} ) . & ( 28 )\end{matrix}$$

Unless they are required for clarity, the sub- and superscripts μₐ, a∈{i, b, o} and σ are suppressed.

As an example, consider an index block on an element e of degree p^{e}=(3, 3), with σ=(−, +), μᵢ=(0, 2), μ_{b}=(1,2), μₒ=(2,2) with the interface along the minimum s boundary. For brevity, let β^{e}=β_{μ}_{ᵢ}_{,μ}_{_{b}}_{,μ}_{ₒ}^{e,σ}. The index block distances for this example are

d_{I⊥}ⁱ(β^{e})=(0) (29)

d_{I∥}ⁱ(β^{e})=(0) (30)

d_{I⊥}^{b}(β^{e})=(1) (31)

d_{I∥}^{b}(β^{e})=(1) (32)

d_{I⊥}^{o}(β^{e})=(1) (33)

d_{Iν}^{o}(β^{e})=(2) (34)

The relevant boundaries and distances for this example are shown in FIG. 9. FIG. 9 depicts an example of a single element index block in an element with p^{e}=(3, 3). The boundary values that define the index block are μᵢ=(3, 0), μ_{b}=(1,2) and μₒ=(2, 2). The orientation of the block is given by σ=(+, −).

6.3.6 Bernstein-Bézier Form

Having defined a mesh with a basis defined over each element, any piecewise function that lies in the function space of each element in the mesh can be represented in terms of the local basis on each element. This is accomplished by assigning a coefficient to each basis function on each element. This is known as the Bernstein-Bézier form of the function. These coefficients are indexed by the same indices defined for the Bernstein basis: bᵢ, where the index i is a global index. Thus, a function ƒ over a mesh M is given by

$$f = {\sum }_{i ∈ I ( {B}^{M} )}^{ } {b}_{i} {B}_{i} . \qquad ( 35 )$$

### 6.4 Splines

A spline is defined as a piecewise function over a given mesh that satisfies the smoothness constraints on every interface in the mesh. Splines are often expressed in Bernstein-Bézier form where the vector of Bernstein coefficients that define the spline must satisfy a set of continuity constraints at every interface in the mesh.

6.4.1 Continuity Constraints

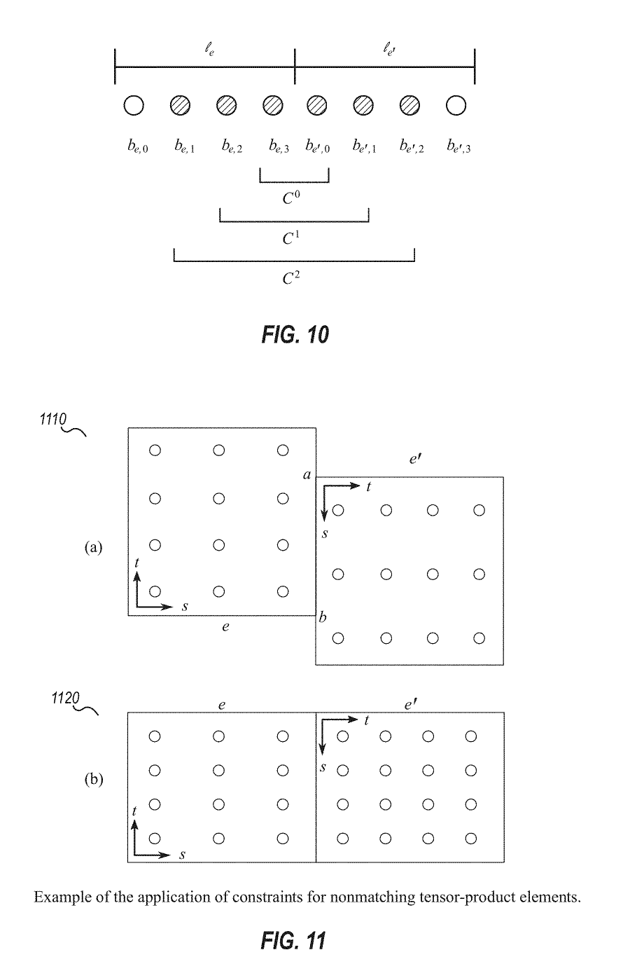

Continuity constraints on functions expressed in Bernstein-Bézier form are now considered. A function over a mesh is said to have continuity of order k or be C^{k} at an interface if all derivatives of order less than or equal to k are continuous between the elements on either side of the interface. A key property of a Bernstein-like basis is that only the coefficients nearest the interface participate in a constraint. This is illustrated for a univariate case in FIG. 10. In FIG. 10, the coefficients that may participate in a C² constraint are indicated by the filled index sites. The indices of the coefficients required for each order of continuity are marked with labeled brackets. These continuity constraints can be expressed in terms of the coefficients of the Bernstein-Bézier form. In general, each continuity constraint for the interface between an element e and a neighbor e′, sharing an interface I, is expressed as a linear system involving only the Bernstein coefficients having indices within a distance k of the interface:

$$\begin{matrix}{{\sum }_{i ∈ I ( {B}^{e} )}}_{{d}_{I} ( i ) \leq k}^{ } {c}_{i}^{I , 1} {b}_{i} = {{\sum }_{{j ∈ I ( {B}^{{e}^{′}} )}_{{d}_{I} ( j ) \leq k}}}^{ } {c}_{j}^{I , 1} {b}_{j} \\ ⋮ & ( 36 ) \\ {{\sum }_{i ∈ I ( {B}^{e} )}^{ }}_{{d}_{I} ( i ) \leq k} {c}_{i}^{I , q} {b}_{i} = {{\sum }_{j ∈ I ( {B}^{{e}^{′}} )}^{ }}_{{d}_{I} ( j ) \leq k} {c}_{j}^{I , q} {b}_{j} . & ( 37 )\end{matrix}$$

The number of constraints q is dependent on the basis on each element adjacent to the interface and the order of continuity required at the interface. The values of the constraint coefficients cᵢ^{I,ƒ} are specific to the local Bernstein basis on each element. Smoothness constraints can also be expressed in matrix-vector format

Sₑ^{I}bₑ=S_{e′}^{I}b_{e′} (38)

where Sₑ^{I} is a q×nₑ matrix; nₑ is the number of basis functions on element e. The entries of the S^{I} matrices are the c coefficients. This matrix equation can be written in nullspace form:

$$[ {S}_{e}^{I} \vert - {S}_{{e}^{′}}^{I} ] [ \frac{{b}_{e}}{{b}_{{e}^{′}}} ] = 0. \qquad ( 39 )$$

The continuity constraints from all interfaces in the mesh M can be collected in a global nullspace expression:

S^{M}b=0. (40)

The vector b represents the Bernstein coefficients of every element in the entire mesh. The Bernstein coefficients of any function that satisfies the smoothness constraints must lie in the nullspace of the smoothness matrix S^{M}.

6.4.1.1 Univariate Constraints

One may begin with continuity constraints on functions expressed in terms of univariate Bernstein bases. If the elements are placed so that the interface I lies at the end of element e and at the beginning of element e′, then the constraint coefficients for the constraint of order k are given by

$$\begin{matrix}{{c}_{i} = \frac{{d}^{k} {B}_{i}}{{ds}^{k}} \vert}_{s = {𝓁}_{e}} & ( 41 ) \\ {{c}_{{i}^{′}} = {ρ}_{{e}^{′}}^{e} \frac{{d}^{k} {B}_{{i}^{′}}}{{ds}^{k}} \vert}_{s = 0} & ( 42 )\end{matrix}$$

where ρ_{e′}^{e}, = [symbol] ₑ/ [symbol] _{e′} and [symbol] ₑ and [symbol] _{e′} are the parametric lengths of the elements e and e′, respectively. For example, any function in Bernstein-Bézier form spanning an interface of continuity k=2, bounded by elements having a Bernstein basis of degree 3, must satisfy the following constraints on its coefficients:

b_{e,3}=b_{e′,0} (43)

3(b_{e,2}−b_{e,3})=3ρ_{e′}^{e}(b_{e′,0}−b_{e′,1}) (44)

6(b_{e,1}−2b_{e,2}+b_{e,3})=6(ρ_{e′}^{e})²(b_{e′,1}−2b_{e′,}1+b_{e′,2}) (45)

where

$$ρ = \frac{{𝓁}_{e}}{{𝓁}_{{e}^{′}}} .$$

These constraints be expressed in matrix form as

$$\begin{matrix}{S}_{e} {b}_{e} = {S}_{{e}^{′}} {b}_{{e}^{′}} \\ where & ( 46 ) \\ {S}_{e} = [ \begin{matrix}0 & 0 & 0 & 1 \\ 0 & 0 & 3 & - 3 \\ 0 & 6 & - 12 & 6\end{matrix} ] \\ and & ( 47 ) \\ {S}_{{e}^{′}} = [ \begin{matrix}1 & 0 & 0 & 0 \\ 3 ( {ρ}_{{e}^{′}}^{e} ) & - 3 ( {ρ}_{{e}^{′}}^{e} ) & 0 & 0 \\ 6 {( {ρ}_{{e}^{′}}^{e} )}^{2} & - 12 {( {ρ}_{{e}^{′}}^{e} )}^{2} & 6 {( {ρ}_{{e}^{′}}^{e} )}^{2} & 0\end{matrix} ] . & ( 48 )\end{matrix}$$

These matrices can be combined into a single matrix

$$S = [ {S}_{e} \vert - {S}_{{e}^{′}} ] = [ \begin{matrix}0 & 0 & 0 & 1 & - 1 & 0 & 0 & 0 \\ 0 & 0 & 3 & - 3 & - 3 ( {ρ}_{{e}^{′}}^{e} ) & 3 ( {ρ}_{{e}^{′}}^{e} ) & 0 & 0 \\ 0 & 6 & - 12 & 6 & - 6 {( {ρ}_{{e}^{′}}^{e} )}^{2} & 12 {( {ρ}_{{e}^{′}}^{e} )}^{2} & - 6 {( {ρ}_{{e}^{′}}^{e} )}^{2} & 0\end{matrix} ] \qquad ( 49 )$$

and the coefficients into a single vector

$$b = [ \frac{{b}_{e}}{{b}_{{e}^{′}}} ] = {[ \begin{matrix}{b}_{e , 0} & {b}_{e , 1} & {b}_{e , 2} & {b}_{e , 3} & {b}_{{e}^{′} , 0} & {b}_{{e}^{′} , 1} & {b}_{{e}^{′} , 2} & {b}_{{e}^{′} , 3}\end{matrix} ]}^{T} \qquad ( 50 )$$

It is not necessary to restrict the method to the configurations having the same Bernstein space on each element of the mesh. For example, the smoothness matrices and coefficient vector for an interface of continuity C¹ where the polynomial degree of the element e is 2 rather than 3 are

$$\begin{matrix}{S}_{e} = [ \begin{matrix}0 & 0 & 1 \\ 0 & 2 & - 2\end{matrix} ] , & ( 51 ) \\ {S}_{{e}^{′}} = [ \begin{matrix}1 & 0 & 0 & 0 \\ 3 ( {ρ}_{{e}^{′}}^{e} ) & - 3 ( {ρ}_{{e}^{′}}^{e} ) & 0 & 0\end{matrix} ] , & ( 52 ) \\ S = [ \begin{matrix}0 & 0 & 1 & - 1 & 0 & 0 & 0 \\ 0 & 2 & - 2 & - 3 ( {ρ}_{{e}^{′}}^{e} ) & 3 ( {ρ}_{{e}^{′}}^{e} ) & 0 & 0\end{matrix} ] , & ( 53 ) \\ b = {[ \begin{matrix}{b}_{e , 0} & {b}_{e , 1} & {b}_{e , 2} & {b}_{{e}^{′} , 0} & {b}_{{e}^{′} , 1} & {b}_{{e}^{′} , 2} & {b}_{{e}^{′} , 3}\end{matrix} ]}^{T} . & ( 54 )\end{matrix}$$

6.4.1.2 a General Approach to Multivariate Constraints

Although the expressions for multivariate constraints vary based on the element types on either side of the interface (tensor-product or simplicial), a common process may be applied. For two elements e and e′ that share an interface I, the trace spaces of the Bernstein spaces on each element restricted to the interface I is denoted by [symbol] ^{e}|_{I} and [symbol] ^{e′}|_{I}. The interface space [symbol] is defined to be the smallest Bernstein-like space of dimension d−1 that contains both trace spaces. In other words, [symbol] ^{e′}|_{I} ∪ [symbol] ^{e′}|_{I}⊆ [symbol] . On each element, a superspace, [symbol] ^{e}, is introduced such that [symbol] ^{e}⊆ [symbol] ^{e} and [symbol] ⊆ [symbol] ^{e}|_{I} and an associated transformation matrix Mₑ: [symbol] ^{e}→ [symbol] ^{e} is determined. Several examples of transformation matrices for common cases are given in Section 6.2.3. The continuity constraints are then imposed on the coefficients in the superspace through the application of Mₑ. To be more precise, the system of equations that constrain the Bernstein coefficients across an interface can be written as

S̅ₑ^{I}Mₑ^{I}bₑ=S̅_{e′}^{I}M_{e′}^{I}b_{e′} (55)

where the matrices S̅ₑ^{I} and S̅_{e′}^{I} are the constraint matrices across the interface I whose coefficients are written in terms of the superspace on each element.

It is important to note that any continuity requirement between two adjacent elements will reduce the local function space at the interface to the intersection of trace spaces of the two adjacent elements. This means that Bernstein spaces that share only constants at the interface will only be able to represent constants. This is primarily of concern for elements with basis functions drawn from QEC spaces. Polynomial bases will always be able to represent polynomials of the same degree as the element of lowest degree.

6.4.1.3 Constraints Between Tensor-Product Elements

The tensor-product basis can naturally be separated into trace and perpendicular function spaces. The base case occurs when both elements share the same trace space. In this case, each line of coefficients perpendicular to the interface must satisfy the univariate constraints presented previously. All other cases may be put in this form by first performing suitable subdivision and degree elevation operations in the directions parallel to the interface as described in Section 6.2.3.

The operators required for the multivariate interface constraints can be constructed by Kronecker products of the appropriate univariate matrices in each parametric direction. As an example, if the elements e and e′ share an interface, as shown in part (a) 1110 of FIG. 11, then the transformation matrices Mₑ and M_{e′} are given by:

Mₑ^{I}=R^{0,a}⊗I₃, (56)

M_{e′}^{I}=I₄⊗(E^{2,1}R^{0,b}) (57)

where a and b are the lengths of the interface in the local coordinate system of each element, I_{d} is the identity matrix of dimension d, and the matrices E and R are defined in Equations (9) and (12). If a and b each occur at ¾ along the side of their respective elements, then the matrices are:

$$\begin{matrix}{R}^{0 , a} = [ \begin{matrix}1 & 0 & 0 & 0 \\ 1 / 4 & 3 / 4 & 0 & 0 \\ 1 / 16 & 3 / 8 & 9 / 16 & 0 \\ 1 / 64 & 9 / 64 & 27 / 64 & 27 / 64\end{matrix} ] , & ( 58 ) \\ {R}^{0 , b} = [ \begin{matrix}1 & 0 & 0 \\ 1 / 4 & 3 / 4 & 0 \\ 1 / 16 & 3 / 8 & 9 / 16\end{matrix} ] , & ( 59 ) \\ {E}^{2 , 1} = [ \begin{matrix}1 & 0 & 0 \\ 1 / 3 & 2 / 3 & 0 \\ 0 & 2 / 3 & 1 / 3 \\ 0 & 0 & 1\end{matrix} ] . & ( 60 )\end{matrix}$$

The final constraint matrices of superspace basis coefficients are found by computing the constraints required to constrain the elements shown in part (b) 1120 of FIG. 11 to satisfy C¹ continuity. Using the univariate constraint matrices

$$\begin{matrix}{S}_{e} = [ \begin{matrix}0 & 0 & 1 \\ 0 & 2 & - 2\end{matrix} ] , & ( 61 ) \\ {S}_{{e}^{′}} = [ \begin{matrix}1 & 0 & 0 & 0 \\ 3 ( {ρ}_{{e}^{′}}^{e} ) & - 3 ( {ρ}_{{e}^{′}}^{e} ) & 0 & 0\end{matrix} ] & ( 62 )\end{matrix}$$

where the ratio of element lengths ρ_{e′}^{e} is the ratio of the perpendicular lengths of the elements, the final constraint matrices are

S̅ₑ^{I}=Sₑ⊗I₃, (63)

S̅_{e′}^{I}=J₄⊗S_{e′} (64)

where J₄ is the exchange matrix:

$${J}_{4} = [ \begin{matrix}0 & 0 & 0 & 1 \\ 0 & 0 & 1 & 0 \\ 0 & 1 & 0 & 0 \\ 1 & 0 & 0 & 0\end{matrix} ] . \qquad ( 65 )$$

The exchange matrix is required because the indexing of element e′ along the interface runs opposite the indexing of element e.

6.4.1.4 Constraints Between Simplicial Elements

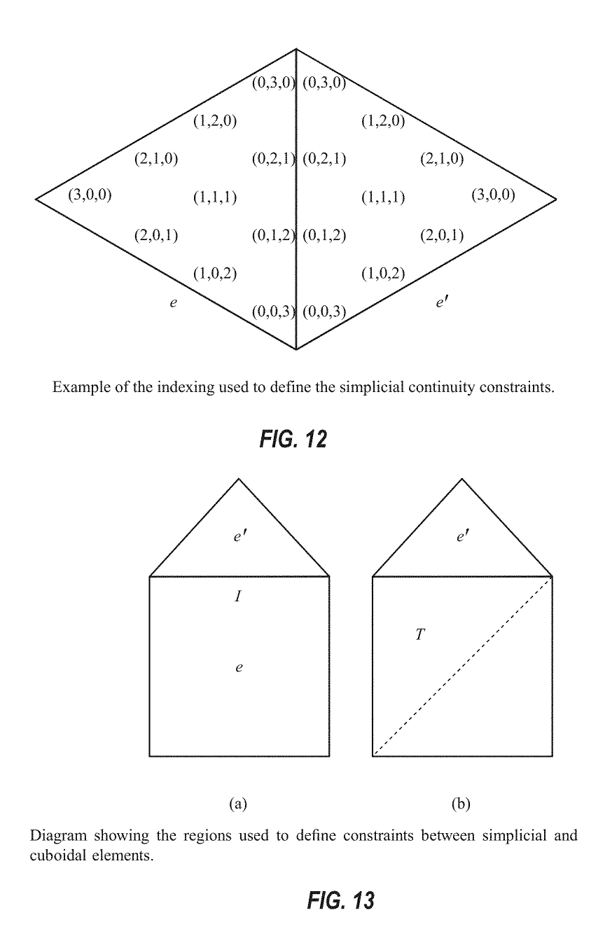

The continuity constraints between simplicial elements have a simple expression in terms of the barycentric coordinate of the opposite vertex of one simplex expressed in terms of the other. Without loss of generality, the interface I between the elements e and e′ is assumed to be opposite the vertex with barycentric coordinate (1, 0, . . . , 0) in both elements. These vertices are denoted vₑ and v_{e′}. Let λ_{e′}^{e}, be the barycentric location of the vertex v_{e′} in the barycentric coordinate system of element e. This convention is illustrated in FIG. 12. Introducing the notation αₒ=(0, α₁, . . . , α_{d+1}) and αₘ=(m, α₁, . . . , α_{d+1}) the constraints of order k can be written as

$${b}_{e , {α}_{m}} = {\sum }_{{‖ μ ‖}_{1} = m}^{ } {b}_{{e}^{′} , {α}_{0} + μ} {B}_{μ}^{m , e} ( {λ}_{{e}^{′}}^{e} ) \qquad ( 66 )$$

for 0≤m≤k. The coordinates αₒ and αₘ satisfy ∥αₘ∥₁=p and ∥αₒ∥₁=p−m. The C⁰ and C¹ constraints on the coefficients for the example shown in FIG. 12 are

b_{e,(0,0,3)}=b_{e′,(0,0,3)}, (67)

b_{e,(0,1,2)}=b_{e′,(0,1,2)}, (68)

b_{e,(0,2,1)}=b_{e′,(0,2,1)}, (69)

b_{e,(0,3,0)}=b_{e′,(0,3,0)}, (70)

b_{e,(1,0,2)}=b_{e′,(0,0,3)}+b_{e′,(0,1,2)}−b_{e′,(1,0,2)}, (71)

b_{e,(1,1,1)}=b_{e′,(0,1,2)}+b_{e′,(0,2,1)}−b_{e′,(1,1,1)}, (72)

b_{e,(1,2,0)}=b_{e′,(0,2,1)}+b_{e′,(0,3,0)}−b_{e′,(1,2,0)}, (73)

Constraints between simplicial elements having differing polynomial degrees can be handled similarly to the tensor-product case where a transformation matrix from the lower degree to the higher degree coefficients is computed and used to transfer the constraints. This was considered by Lai et al. Refinement is handled in a similar fashion to the tensor-product case where a refined basis is constructed and the constraints are imposed on the refined coefficients and then transferred to the original coefficients.

6.4.1.5 Constraints Between Elements of Differing Type

In order to compute constraints between elements of differing type (simplicial and cuboidal), a simplicial subdomain T of the cuboidal element that shares the interface with the adjacent simplicial element is chosen. An auxiliary basis capable of representing the tensor-product basis is defined over this domain and the transformation matrix T that expresses coefficients of the tensor-product basis in terms of the simplicial basis is computed. If the element e is cuboidal then the constraint equation Equation (55) becomes

S̅_{T}^{I}M_{T}^{I}Tbₑ=S̅_{e′}^{I}M_{e′}^{I}b_{e′}. (74)

An example of this is shown in FIG. 13. The constraints across the interface I between the quadrilateral element e and the triangular element e′ shown in part (a) 1310 are computed by introducing the auxiliary subdomain T shown in part (b) 1320.

6.4.2 Splines as a Solution to a Nullspace Problem

The Bernstein coefficients that define a spline must lie in the nullspace of the mesh smoothness constraint matrix S^{M}:

S^{M}b=0. (75)

The matrix S^{M} is produced by assembling the smoothness constraint matrices from ever single interface into one global matrix. A spline space S^{M} is the function space consisting of all splines over a given mesh M with a local basis assigned to each element in the mesh and smoothness conditions assigned to each interface in the mesh.

One significant area of research in the theory of splines is the determination of the dimension of a spline space from a mesh and assigned smoothness constraints. Because the Bernstein coefficient vectors of all functions in a spline space lie in the nullspace of the mesh smoothness constraint matrix, the dimension of the spline space can theoretically be determined from the rank-nullity theorem:

dim(S^{M})=dim(B^{M})−rank(S^{M}). (76)

This approach quickly becomes intractable for meshes of even moderate size; accurate determination of even the rank of a large matrix of floating point numbers is a difficult problem. One approach was given by Alfeld.

6.4.3 Spline Bases

An important tool in the definition, construction, and use of splines is the spline basis. As with any vector space, any spline in a spline space can be represented as a linear combination of the members of a linearly independent set of functions having the same number of elements as the dimension of the spline space. Such a set of functions is referred to as a basis for the spline space.

Let Σ^{M} be a set of vectors that span the nullspace of S^{M}. In other words, span(Σ^{M})=Null(S^{M}). Assume that the entries of the vectors can be indexed using the ordering given by I(B^{M}). Then a set of basis functions S^{M} that span the spline space S^{M} is given by

$${S}^{M} = \{ N \vert N = {\sum }_{i ∈ I ( {B}^{M} )}^{ } {[ σ ]}_{i} {B}_{i} , σ ∈ {\sum }^{M} \} . \qquad ( 77 )$$

Here B^{M} is the set of Bernstein basis functions for the entire mesh.

The most recognized example of a spline space and its associated basis is the B-splines or basis splines. Originating with Cox, de Boor, and Mansfield, the basis spline functions are the minimally supported spline functions on a partitioning of an interval. The minimal, compact support of B-splines is significant for both design and analysis. Indeed, nonuniform rational B-splines (NURBS) form the basis of virtually all previous CAD modeling environments and have been employed extensively in isogeometric analysis and its predecessors.

Much of the previous work on splines outside of B-splines has focused on determining the dimension of the spline space and then finding a basis for the spline space. This basis is often constructed as an object known as a minimal determining set, especially in the case of splines over triangulations. Finding a minimal determining set corresponds to finding a basis of the appropriate size for the spline space. However, it does not provide any insight into the quality or utility of a basis other than existence. Of more practical use is an algorithm for the direct construction of a basis for a spline space that satisfies the desirable properties of the B-splines: minimal support and positivity. An important corollary of the minimal support property of the B-splines that is not often appreciated is the fact that the minimal support property requires that when a single B-spline function is expressed in Bernstein-Bézier form, the function is minimally supported in the number of nonzero Bernstein coefficients. In algebraic terms, this means that the vectors of Bernstein coefficients of the B-spline functions form the sparsest basis of the nullspace of the smoothness constraint matrix. The problem of finding the sparsest basis for the nullspace of a matrix is known as the Null Space Problem and has been shown to be NP-hard.

The sparsity property of the basis can be observed in the basis of the nullspace of the smoothness constraint matrix presented in Equation (50). If both elements are the same length, then the ratio ρ=1 and the smoothness constraint matrix is

$${S}^{M} = [ \begin{matrix}0 & 0 & 0 & 1 & - 1 & 0 & 0 & 0 \\ 0 & 0 & 3 & - 3 & - 3 & 3 & 0 & 0 \\ 0 & 6 & - 12 & 6 & - 6 & 12 & - 6 & 0\end{matrix} ] \qquad ( 78 )$$

It can be shown that the sparsest basis for the matrix S^{M} is

$$[ \begin{matrix}1 \\ 0 \\ 0 \\ 0 \\ 0 \\ 0 \\ 0 \\ 0\end{matrix} ] , [ \begin{matrix}0 \\ 1 \\ 1 / 2 \\ 1 / 4 \\ 1 / 4 \\ 0 \\ 0 \\ 0\end{matrix} ] , [ \begin{matrix}0 \\ 0 \\ 1 / 2 \\ 1 / 2 \\ 1 / 2 \\ 1 / 2 \\ 0 \\ 0\end{matrix} ] , [ \begin{matrix}0 \\ 0 \\ 0 \\ 1 / 4 \\ 1 / 4 \\ 1 / 2 \\ 1 \\ 0\end{matrix} ] , [ \begin{matrix}0 \\ 0 \\ 0 \\ 0 \\ 0 \\ 0 \\ 0 \\ 1\end{matrix} ] \qquad ( 79 )$$

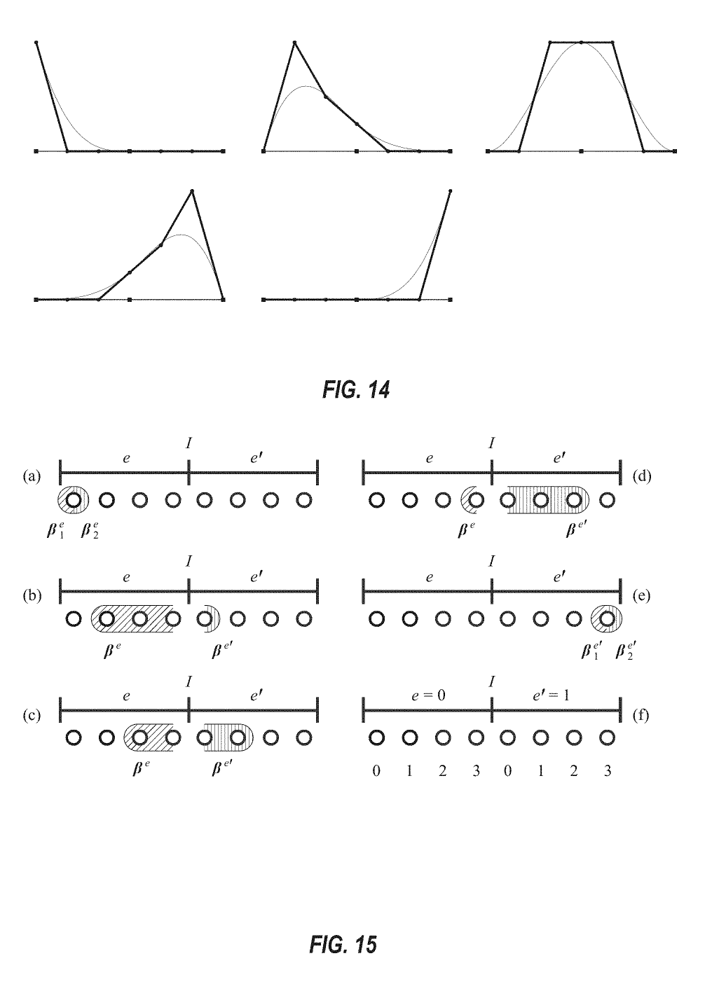

and that these vectors correspond to the rows of the global Bézier extraction matrix for this mesh; i.e. these are the coefficients of the B-splines expressed in Bernstein-Bézier form. The associated spline basis functions are shown in FIG. 14. FIG. 14 depicts plots of the B-spline basis function coefficient values (round markers) and the corresponding spline basis functions (thin lines).

6.5 Constrained Index Blocks

6.5.1 Introduction

The idea of a constrained index block can be motivated by several simple observations emanating from the properties of Bernstein-like bases in one-dimension. The key observation is this: Bernstein-like basis functions vanish n times at an interface where n is the index distance between the function index i and the interface I. As a result, if the distance from the index to the interface is greater than the continuity of the interface (i.e., n>k(I)), then setting the value of coefficient bᵢ on element e has no impact on the coefficients associated with basis functions between i and the interface I on element e or on element e′. In this case, the constrained index block only spans the single index i. However, if the index distance is less than or equal to the continuity of the interface then the constrained index block spans all the coefficients between i and the interface I on element e and those having an index within a distance k(I)−n of the interface I on element e′. In other words, all these coefficients are constrained by choosing the value of the coefficient associated with index i on element e.

It is convenient to formalize these observations in terms of element index blocks. Starting with an index block β^{e} having an outward orientation pointing away from interface I the bounds of the block are initialized so that the originating index is the only member of β^{e}. If the inner bound of the index block is within a distance less than or equal to the continuity of the interface I (i.e., d_{I⊥}ⁱ (β^{e})≤k(I)), then the inner bound is adjusted to match the index location of the interface. An index block in the adjacent element e′ is then constructed with bounds chosen such that

d_{I⊥}ⁱ(β^{e′})=0

and

d_{I⊥}ⁱ(β^{e′})=k(I)−d_{I⊥}ⁱ(β^{e}).

Here the outward bounds match the barrier: μₒ=μ_{b}. This will always be the case for one-dimensional meshes. If the index block is far enough from a boundary that it doesn't couple through that boundary, then another block is added to represent a closed set of blocks.

Several examples for a two-element mesh are shown in FIG. 15. Both elements have

TABLE 3
Orientation and bounding values for
the element index blocks in FIG. 15.

| | | |
|---|---|---|
| (a) | β₁^{e} | σ = (−) |
| | | μᵢ = (0) |
| | | μ_{b} = (0) |
| | | μₒ = (0) |
| | β₂^{e} | σ = (+) |
| | | μᵢ = (0) |
| | | μ_{b} = (0) |
| | | μₒ = (0) |
| (b) | β^{e} | σ = (−) |
| | | μᵢ = (3) |
| | | μ_{b} = (1) |
| | | μₒ = (1) |
| | β^{e}′ | σ = (+) |
| | | μᵢ = (0) |
| | | μ_{b} = (0) |
| | | μₒ = (0) |
| (c) | β^{e} | σ = (−) |
| | | μᵢ = (3) |
| | | μ_{b} = (2) |
| | | μₒ = (2) |
| | β^{e}′ | σ = (+) |
| | | μᵢ = (0) |
| | | μ_{b} = (1) |
| | | μₒ = (1) |
| (d) | β^{e} | σ = (−) |
| | | μᵢ = (3) |
| | | μ_{b} = (3) |
| | | μₒ = (3) |
| | β^{e}′ | σ = (+) |
| | | μᵢ = (0) |
| | | μ_{b} = (2) |
| | | μₒ = (2) |
| (e) | β₁^{e}′ | σ = (−) |
| | | μᵢ = (3) |
| | | μ_{b} = (3) |
| | | μₒ = (3) |
| | β₂^{e}′ | σ = (+) |
| | | μᵢ = (3) |
| | | μ_{b} = (3) |
| | | μₒ = (3) |

polynomial degree p=3. The interface I between the elements is C² (k(I)=2). FIG. 15 depicts the constrained index blocks which can be defined on two elements of degree 3 with a C² interface (k(I)=2) between the elements. In this simple case, each constrained index blocks coincides with the function support of a B-spline function. The basis functions for this example are shown in FIG. 14. The orientation and bounding values for this figure are shown in Table 3. All possible constrained index blocks are shown. The constrained index blocks in this example correspond to the indices of the sets of nonzero coefficients of the basis functions over this mesh. These basis functions were considered previously and are shown in FIG. 14. The values of each defining property of the element index blocks that make up each constrained index block shown in FIG. 15 are given in Table 3.

6.5.2 Notation

The symbol κ is used to represent a constrained index block. Corners are key features of a constrained index block. The corners of a constrained index block are the indices for which at least d neighboring indices are not in the index set (d is the parametric dimension of the mesh). The set of indices corresponding to the corners of a constrained index block are denoted by C(κ). The set of originating indices from which the constrained index block can be constructed is called a seed set (seed(κ)). In the univariate case, the corner and seed sets always coincide but this is not the case for the general multivariate setting.

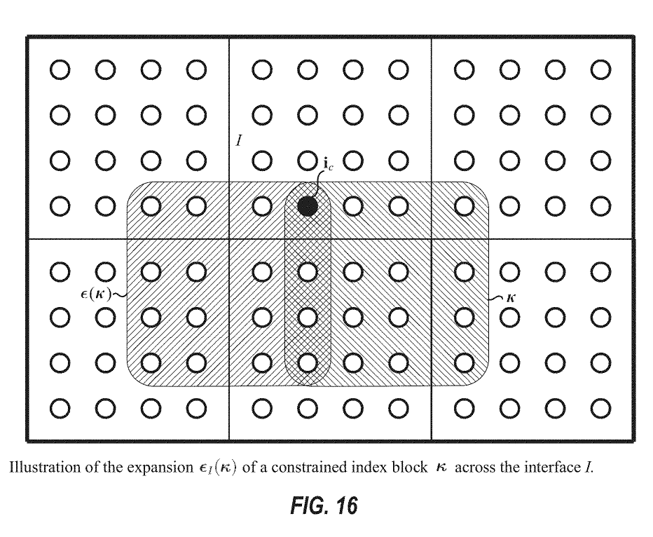

It is also helpful to define notation for the expansion of a constrained index block across an interface. Given a constrained index block κ, the expansion of κ is the constrained index block produced by identifying the corner index i_{c} of κ that is nearest the interface I, determining the index block βₐ that contains the corner, and constructing a new constrained index block that has an index block β_{b} that shares the corner i_{c} and has all orientations equal to βₐ except the one in the direction of the interface I. A constrained index block is denoted by ε_{I}(βₐ). An example of a constrained index block κ and its expansion across an interface I is shown in FIG. 16.

6.5.3 the Multivariate Setting

A multivariate constrained index block is defined as the smallest set of element index blocks having a seed index i in its corner set and where for each index block β^{e} in the set, there is another index block on an adjacent element β^{e′} such that if σ_{I∥}(β^{e})=σ_{I∥}(β^{e′}) then either β^{e}|_{I}⊆β^{e′}|_{I} or β^{e′}∥_{I}⊆β^{e}∥_{I}; if σ_{I∥}(β^{e})≠σ_{I∥}(β₀^{e′}) then there is a β₁^{e′} having σ_{I∥}(β₁^{e′})=σ_{I∥}(β^{e}), β^{e}|_{I}⊆^{e′}₁^{e′}|_{I} or β₁^{e′}|_{I}⊆β^{e}|_{I} and d_{I⊥}^{a}(β₀^{e′})=d_{I⊥}^{a}(β₁^{e′})∀a∈{i,b,o}. Such a set can be produced by a flood algorithm. Various considerations required to successfully transition across different types of interfaces are given in the sections that follow.

6.5.4 Block Transfer Across Matching Interfaces

Two elements match across an interface if the shared interface spans the entire side of both elements and if the basis in each parametric direction matches in each shared parametric direction parallel to the interface. For polynomial Bernstein bases this requires p_{I∥}^{e}=p_{I∥}^{e′}. In general, the orientations of the two elements e and e′ will not be aligned and so the equality is assumed to hold only after an appropriate identification between parametric directions in the two elements has been made. The subscript I^{∥} is used to represent quantities that have been appropriately transformed to lie on the interface I.

In order to produce a function that is continuous across an element interface, the coefficients in each line perpendicular to the interface must satisfy the one-dimensional continuity constraints. When constructing a constrained index block that spans the interface, this requires that the perpendicular size of the element index blocks on both sides of the interface must match. Additionally, the same rule used in the one-dimensional case to construct an element index block on an adjacent element must be applied in the perpendicular direction.

In precise terms, given elements e and e′ that share an interface I and an element index block that that satisfies d_{I⊥}^{b}(β^{e})≤k(I) and d_{I⊥}ⁱ(β^{e})=0, construct an element index block β^{e′} such that

d_{I∥}ⁱ(β^{e′})=d_{I∥}ⁱ(β^{e}), (80)

d_{I∥}^{b}(β^{e′})=d_{I∥}^{b}(β^{e}), (81)

d_{I∥}^{o}(β^{e′})=d_{I∥}^{o}(β^{e}), (82)

σ_{I∥}(β^{e′})=σ_{I∥}(β^{e}), (83)

d_{I⊥}ⁱ(β^{e′})=0, (84)

d_{I⊥}ⁱ(β^{e′})=k(I)−d_{I⊥}^{b}(β^{e}), (85)

d_{I⊥}(β^{e′})≠σ_{I⊥}(β^{e}). (86)

These requirements are general. There are specific subtleties associated with some configurations but the basic requirements on adjacent blocks remain the same.

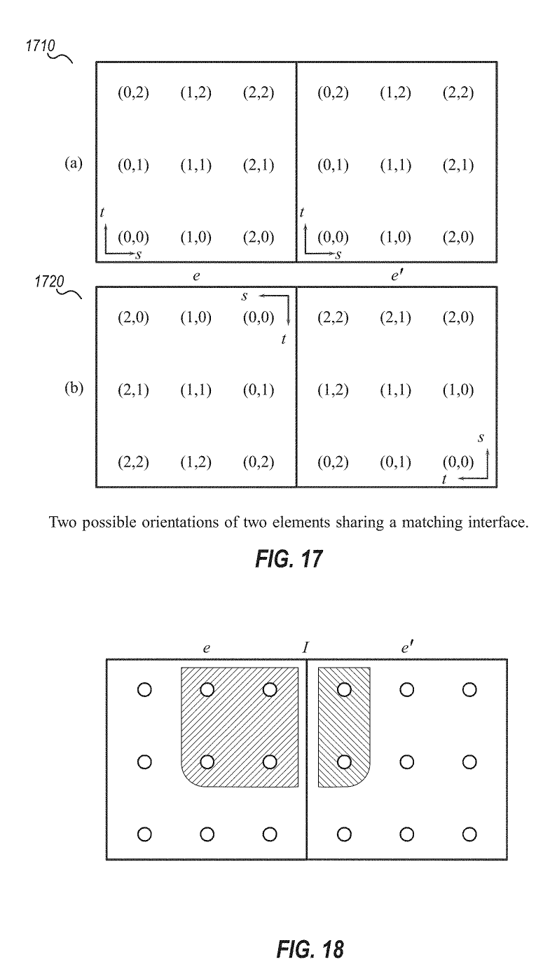

An example of the required relationships is given in FIGS. 17 and 18. FIG. 17 shows two possible orientations, 1710 and 1720, of two elements that share a matching interface I

TABLE 4
Orientation and bounding values for the element index
blocks in FIG. 18. The (a) and (b) refer to the two
different indexing schemes shown in FIG. 17

| | | |
|---|---|---|
| (a) | β^{e} | σ = (−, −) |
| | | μᵢ = (2, 2) |
| | | μ_{b} = (1, 1) |
| | | μₒ = (1, 1) |
| | β^{e}′ | σ = (+, −) |
| | | μᵢ = (0, 2) |
| | | μ_{b} = (0, 1) |
| | | μₒ = (0, 1) |
| (b) | β^{e} | σ = (+, +) |
| | | μᵢ = (0, 0) |
| | | μ_{b} = (1, 1) |
| | | μₒ = (1, 1) |
| | β^{e}′ | σ = (−, −) |
| | | μᵢ = (2, 2) |
| | | μ_{b} = (1, 2) |
| | | μₒ = (1, 2) |

along with the indexing of the Bernstein basis on each element. FIG. 18 shows the layout of two element index blocks that satisfy Equations (80) to (86). FIG. 18 depicts adjacent element index blocks that satisfy Equations (80) to (86) on adjacent matching elements. The degree of each element is p=(2, 2) and the interface continuity is k(I)=1. The orientation is indicated by rounding the outermost corner. An explicit indexing is not required to illustrate the blocks. The bounding values and orientations for the blocks under the two indexing options shown in FIG. 17 are given in Table 4.

6.5.5 Block Transfer Across Interfaces Adjacent to T-Junctions

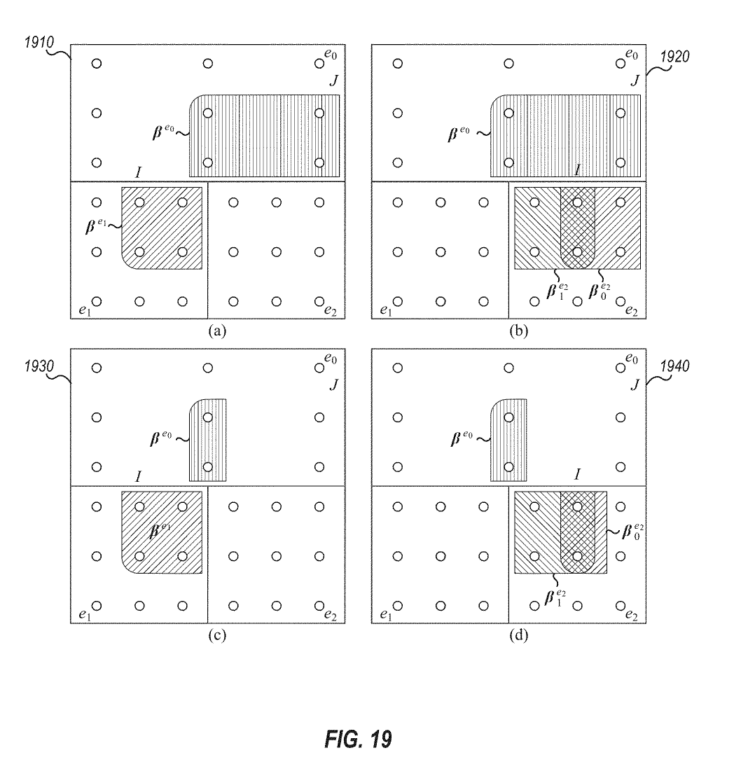

In order to transition across an interface that is adjacent to a T-junction in the mesh four cases shown in FIG. 19 are considered. FIG. 19 depicts examples of index blocks computed to maintain compatibility across the interface I. Each case corresponds to two possible scenarios: computing an element index block in the large element, given an element index block in a small adjacent element or computing an element index block in a small element, given an element index block in the large element. The interface between the elements is indicated by I. The interface J represents the side of the element that lies in the inward direction of the element index block and is not parallel to the interface I.

First, consider the scenario of constructing an element index block in the small element, given an element index block in the large element β^{e}^{₀}. If d_{J⊥}ⁱ=0 as shown in part (a) 1910 of FIG. 19 and the index nearest the T-junction vertex in the small element lies in the inward direction of the outward bounds induced by β^{e}^{₀} then Equations (80) to (86) are used to produce the index block β^{e}^{₁}. If d_{J⊥}ⁱ=0 but the interface I is specified so that the index nearest the T-junction vertex in the small element lies in the outward direction of the induced outward bound as shown in part (b) 1920 of FIG. 19, then Equations (80) to (86) are used to produce one index block β₀^{e}^{₂}. Another element index block β₁^{e}^{₂} is also created that satisfies the perpendicular block requirements Equations (84) to (86) but has the following requirements relative to β₀^{e}^{₂} for the direction parallel to the interface:

σ_{I∥}(β₁^{e}^{₂})=−σ_{I∥}(β₀^{e}^{₂}), (87)

σ_{I∥}ⁱ(β₁^{e}^{₂})=0, (88)

σ_{I∥}^{b}(β₁^{e}^{₂})=d_{I∥}^{o}(β₀^{e}^{₂}), (89)

σ_{I∥}^{o}(β₁^{e}^{₂})=d_{I∥}^{b}(β₀^{e}^{₂}), (90)

If the distance d_{I∥}ⁱ(β^{e}^{₀})>0 and the T-junction is in the inward direction on the small element then the element index block on the smaller element is expanded so that d_{I∥}ⁱI(β^{e}^{₀})=0. This is illustrated in part (c) 1930 of FIG. 19.

If the distance d_{I∥}ⁱI(β^{e}^{₀})>0 and the T-junction is in the outward direction on the small element then the element index block on the smaller element is not expanded and the secondary block is computed as before. This is shown in part (d) 1940 of FIG. 19.

6.5.6 Block Transfer Across Interfaces Between Elements of Different Degree

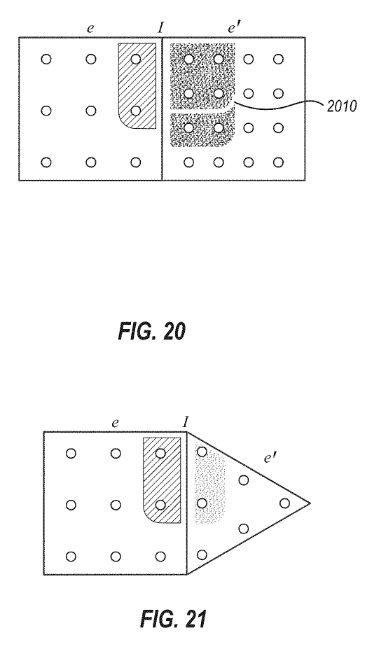

The matching requirements for element index blocks given in Equations (80) to (86) can be used without modification to construct element index blocks between elements with differing polynomial degree. It is important to note that although d_{I∥}^{b}(β^{e′})=d_{I∥}^{b}(β^{e}) and d_{I∥}^{o}(β^{e′})=d_{I∥}^{o}(β^{e}), the values of the bounds in the element index block on the element of higher degree (e′) are not equivalent. In this case, μₒ(β^{e′})≠μ_{b}(β^{e′}). A two element example with one element having degree p^{e}=(2, 2) and the other degree p^{e′}=(3, 3) is shown in FIG. 20. FIG. 20 depicts adjacent element index blocks that satisfy Equations (80) to (86) on adjacent elements having different polynomial degree. The degree of the element e is p^{e}=(2, 2), the degree of element e′ is p^{e′}=(3, 3), and the interface continuity is k(I)=2. Due to the difference in degree between the elements, the barrier bound is different from the outer bound. The barrier bound is indicated by a white line. The distinct barrier bound is indicated by a white line 2010. For this case,

d_{I∥}ⁱ(β^{e})=d_{I∥}ⁱ(β^{e′})=0, (91)

d_{I∥}^{b}(β^{e})=d_{I∥}^{b}(β^{e′})=1, (92)

d_{I∥}^{o}(β^{e})=d_{I∥}^{o}(β^{e′})=1. (93)

6.5.7 Block Transfer Across Interfaces Between Elements of Different Type

The algorithms presented here can also be adapted to accommodate meshes containing elements of differing types, for example quadrilaterals and triangles or tetrahedra and hexahedra. All elements possess a Bernstein basis and each Bernstein basis reduces to a Bernstein basis of dimension one less on the boundaries. As such, the same reasoning can be applied to transfer index blocks across interfaces. The only consideration is the differing parametric descriptions used on each side. An example of a transfer between a square and a triangle element is shown in FIG. 21. The interface has continuity k(I)=1.

6.5.8 an Illustrative Example Containing Multiple Adjacent T-Junctions

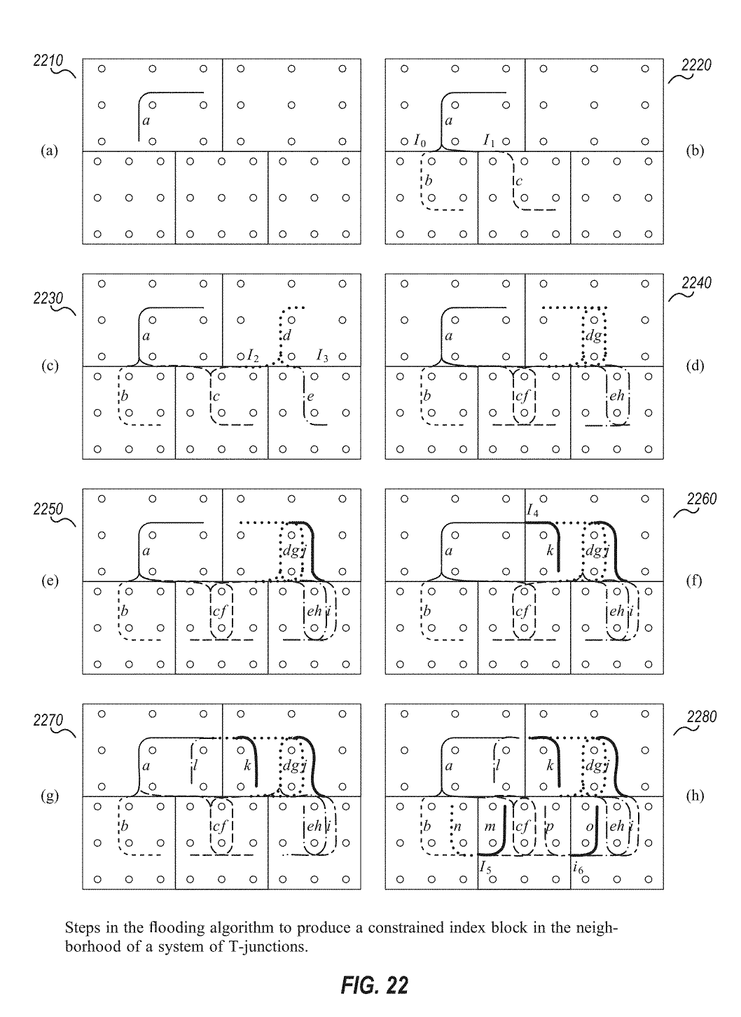

Consider the example in FIG. 22. In part (a) 2210, the algorithm is initialized with the element index block βₐ. The notion of connections between index blocks is used here. Typical flooding methods require data as to which directions have already been processed. A connection between two index blocks indicates a processed direction. Part (b) 2220 shows the result of constructing the element index block β_{b} across the interface I and connecting it to the original block βₐ. The connections are used to illustrate the relationships between the blocks and are also useful in determining open boundaries for the flood. Similarly, the element index block β_{c} is constructed and connected across the interface J. Both of the these blocks conform to βₐ across their respective shared interfaces: βₐ|_{I}=β_{b}|_{I} and βₐ|_{J}=β_{c}|_{J}. In part (c) 2230, the blocks produced by processing β_{c} on interface K and then processing the resulting block β_{d} on interface L to obtain βₑ are shown. Part (d) 2240 shows the blocks that are added to account for the presence of the T-junction. Each of the new blocks has an orientation opposite the base block produced earlier in the flood: σ_{I}_{₁}_{∥}(β_{c})≠σ_{I}_{₁}_{∥}(β_{ƒ}), σ_{I}_{₁}_{∥}(β_{d})≠σ_{I}_{₁}_{∥}(β_{g}), and σ_{I}_{₃}_{∥}(βₑ)≠σ_{I}_{₃}_{∥}(βₕ). Each block is connected to the same blocks as the base block across the relevant interface. Thus, block β_{ƒ} is connected to blocks βₐ and β_{d}. Similar connections are made for blocks β_{ƒ}, β_{g}, βₕ. The remaining interfaces perpendicular to I₀, I₁, I₂, I₃ are now processed. Part (e) 2250 shows the result of processing the open index blocks β_{d} and βₑ and the resulting connection between them obtained by processing the interface I₃. There is no element in the open direction for either of these blocks and so the placeholder blocks βᵢ and βⱼ are inserted and connected. Processing βₐ across interface I₄ produces βₖ (part (ƒ) 2260) while processing β_{g} across the same interface produces βₗ (part (g) 2270). Similarly, in part (h) 2280, the blocks β_{b}, β_{ƒ} produce the element index blocks βₘ, βₙ, respectively, when processed across the interface I₅ and the element index blocks β_{c} and βₕ processed across the interface I₆ produce the blocks βₒ and βₚ. The flood now terminates as the remaining element index blocks without connections across interfaces (βₖ, βₗ, βₘ, βₙ, βₒ, βₚ) are subsumed by other blocks that do have connections across those interfaces (i.e., βₙ⊂β_{b}, etc.).

### 6.6 Function Index Support

The set of indices associated with nonzero Bernstein coefficients in the support of one basis function is referred to as a function index support. A function index support ϕ is the union of the indices in a set of constrained index blocks such that

$$φ = {⋃}_{κ ∈ {K}_{i}} I ( κ ) \qquad ( 94 )$$

where the set of constrained index blocks Kᵢ associated with the index i is defined as the smallest set of constrained index blocks where every member shares at least one corner with another member, at least one member of the set has the index i as a member of its corner set, and every index o in the boundary set ∂I(Kᵢ) is greater than a distance k(I) from every interface I perpendicular to the outward boundary direction associated with the index o. Additionally, for each element index block β in each possible extension of a constrained index block κ, there must be some other constrained index block κ′ in the set that has an index block β′ satisfying β⊆β′. More precisely, in set-theoretic notation, these conditions can be written as

∃κ∈Kᵢ:i∈C(κ), (95)

∀κ∈Kᵢ∃κ′∈Kᵢ: C(κ)∪C(κ′)≠Ø (96)

∀o∈∂I(kᵢ),∀I∈M:I⊥n(o),d_{I⊥}(o)>k(I), (97)

∀κ∈Kᵢ,∀I∈∂Ω(I(κ)),∀β∈ϵ_{I}(κ)∃κ′∈Kᵢ:β⊆β′,β′∈κ′. (98)

The set of all function index supports defined over a given mesh is denoted by {ϕ_{A}} and the corner set of a function index support by C(ϕ_{A}). Here we use the operator ∂ to indicate the boundary of a set. If the set is a set of indices, then the boundary is all members of the set that are not surrounded on all sides by other members of the set. The operator producing the normal with respect to an index n is also used. This provides a parametric direction in which the input index has no neighbors. The parametric support of an index set is represented by Ω(I). This represents the union of the parametric domains of all elements having indices in the set I.

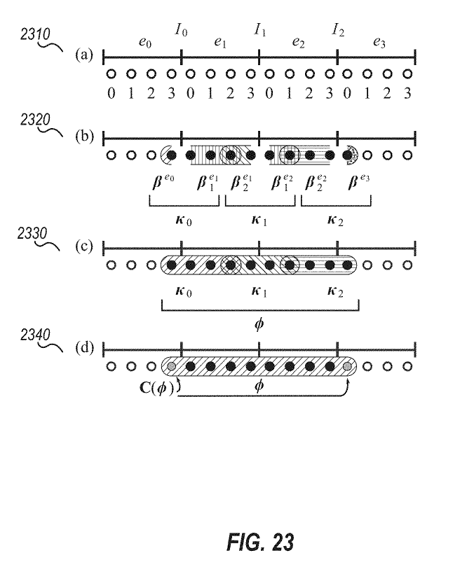

These properties are illustrated for the univariate case through an example. Consider the univariate mesh shown in FIG. 23. FIG. 23 depicts a univariate mesh consisting of 4 elements with a basis of polynomial degree 3 on each element. The figure shows index, element, and interface labels (a), the element index blocks that make up the support of the function (b), the constrained index blocks formed from the element index blocks (c), and the full function index support ϕ with the indices that are part of the corner set C(ϕ) shown in light grey (d). The properties of the element index blocks are given Table 5. It consists of 4 elements, {eᵢ|i∈{0, 1, 2, 3}} and 3 interfaces {Iᵢ|i∈{0, 1, 2}}. Each element is assigned a basis with polynomial degree p^{e}^{ᵢ}=3 and the continuity of each interface is k(Iᵢ)=2. A seed index iₛ is selected. Here it is assumed that the index carries both the element e and the local index of a single function. This corresponds to a single Bernstein coefficient that will be nonzero in our final function. The minimum set of coefficients that must be nonzero while still satisfying the continuity constraints on either side of element e are then determined. The indexing of the relevant quantities is shown in part (a) 2310. The element index blocks that make up the function index support are shown and labeled in part (b) 2320. The element index blocks on elements with more than one block carry an additional identifying subscript. The element index

TABLE 5
Orientation and bounding values for
the element index blocks in FIG. 23.

| | | | | | |
|---|---|---|---|---|---|
| β^{e}^{₀} | σ = (−) | β₁^{e}^{₁} | σ = (+) | β₂^{e}^{₂} | σ = (−) |
| | μᵢ = (3) | | μᵢ = (0) | | μᵢ = (3) |
| | μ_{b} = (3) | | μ_{b} = (2) | | μ_{b} = (2) |
| | μₒ = (3) | | μₒ = (2) | | μₒ = (2) |
| β₁^{e}^{₂} | σ = (+) | β₂^{e}^{₂} | σ = (−) | β^{e}^{₃} | σ = (+) |
| | μᵢ = (0) | | μᵢ = (3) | | μᵢ = (0) |
| | μ_{b} = (1) | | μ_{b} = (1) | | μ_{b} = (0) |
| | μₒ = (1) | | μₒ = (1) | | μₒ = (0) |

blocks that make up each of the constrained index blocks κᵢ are indicated. The constrained index blocks are shown with labels in part (c) 2330. Finally, the function index support ϕ is shown in part (d) 2340 along with the members of the corner index set C(ϕ) marked in gray.

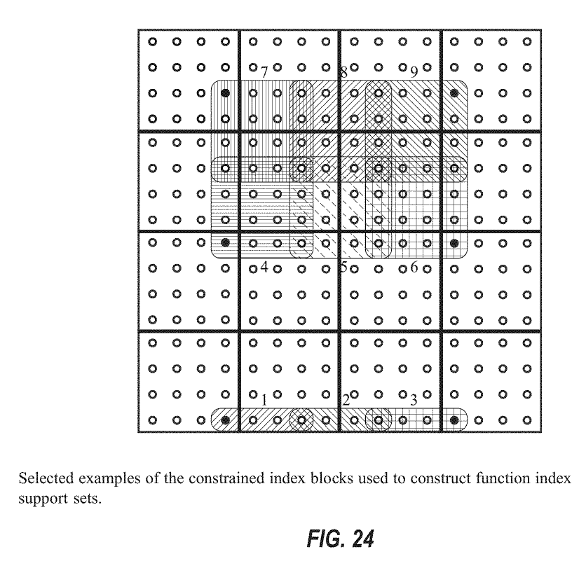

Several examples of multivariate functions index supports are shown in FIG. 24. The constrained index blocks that make up each function index support are assigned indices from 1-9. The seed indices are marked with filled circles. Note that some care must be taken when forming the underlying constrained index blocks in the multivariate setting as described in Section 6.5.

### 6.7 U-Spline Basis Construction

As noted previously, for a given mesh there is a basis for the associated spline space that corresponds to the sparsest basis for the nullspace of the smoothness constraint matrix. Using a brute force approach to solve the nullspace problem and determine the members of this basis is an intractable problem. To avoid these issues, the U-spline approach leverages the mesh topology and properties of a Bernstein-like basis in order to incrementally construct member functions of the sparsest possible spline basis without directly solving the global nullspace problem. Note that although this approach is generally applicable to bases that satisfy the properties of a Bernstein-like basis given in Section 6.2.2, for simplicity, only examples using polynomial Bernstein bases are considered.

6.7.1 Outline of U-Spline Basis Construction

A basic outline of how U-spline basis functions are constructed is as follows:

1. Input a mesh containing:
Cuboidal or simplicial elements and connectivity between adjacent elements.
Parameteric data assigned to each edge of every element, including parametric length and direction within the local coordinate system of the element.
Specification of the desired level of continuity on each interface between elements.
Sufficient data to define a Bernstein-like basis on each element. For polynomial Bernstein bases, it is sufficient to specify the polynomial degree in each parametric direction.

2. For each seed Bernstein index:
a) Construct the function index support that has the seed as a corner through the following steps:
   i. Determine a constrained index block having the seed as a corner and mark it.
   ii. Mark any unmarked constrained index blocks sharing corners and having minimal overlap with previously marked blocks until no new blocks can be marked.
   iii. if the seed index is not a corner of the function support then continue to the next available seed.
b) Determine whether a function with the same function index support has already been created.
c) If the function index support is new, determine the coefficient values through the following steps:
   i. Form the smoothness constraint matrix for the coefficients corresponding to the indices in the function index support.
   ii. Solve for the vector that defines the nullspace of the constraint matrix. The entries in this vector are the Bernstein coefficients that define the function.

3. The functions determined in the previous step must be normalized so that for each index in the mesh, the sum of all nonzero coefficients sharing that index for all basis functions over the mesh is equal to one. This is accomplished by forming and solving a linear system.

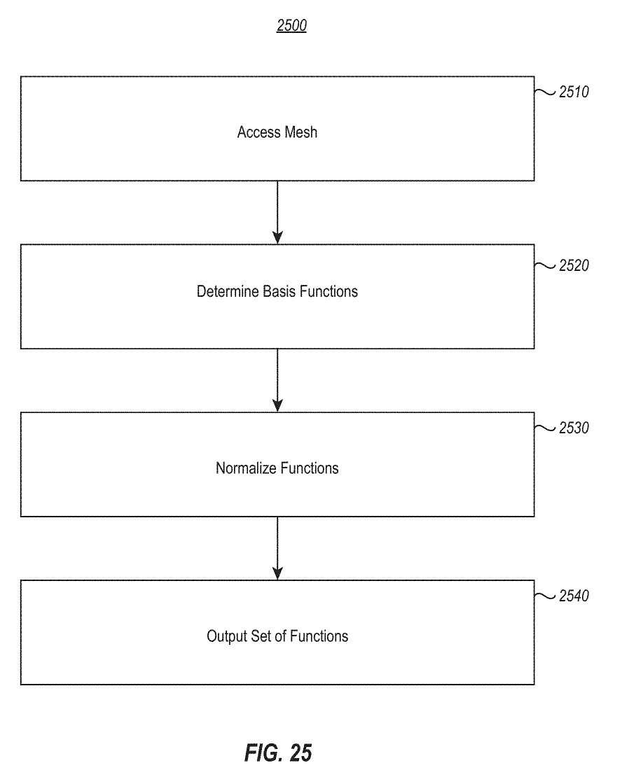

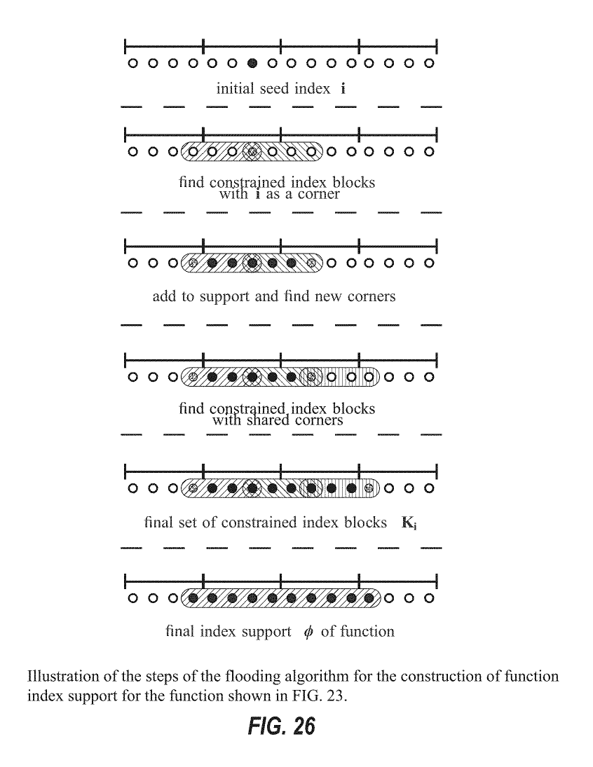

Various details of particular embodiments of the construction process are now described in more detail herein and below. For example, FIG. 25 illustrates a method for constructing a U-spline basis over a mesh. The method includes accessing 2510 a mesh. The mesh could be a mesh output or otherwise provided by a CAD design process. The mesh may also be a mesh output from an FEA process. The method also includes determining basis functions 2520. Determining basis functions includes constructing function index support and determining coefficient values for the functions.

The method also includes normalizing 2530 the determined basis functions such that, for each index in the mesh, the sum of all nonzero coefficients sharing that index for all basis functions over the mesh is equal to one. Finally, the determined (and normalized) set of functions are output for further use in CAD, FEA, or other uses. Of course, the determined set of functions may also be saved in durable data storage to be used, output, or transported at some future time. Each of these steps are discussed more thoroughly and in additional detail throughout.

6.7.2 Construction of Function Index Supports

To make the function index support determination phase of the U-spline construction process more concrete, additional important details are given. Beginning with a seed index i, Step (1) adds all constrained index blocks κ satisfying i∈seed(κ)∩C(κ) to the set Kᵢ. Then, in Step (2) the corners of this new set are computed. In Step (3), all constrained index blocks satisfying C(κ)∩seed(κ)∩C(Kᵢ)≠0 are added to the set. Steps (2) and (3) are repeated until no new constrained index blocks are added. The steps of this algorithm are illustrated in FIG. 26 for a single function. This example begins with a seed index that is not a member of the final corner set. Although this approach works well in one-dimension, in a multivariate setting it is wise to choose seed indices that are located within an element such that they do not couple with any interfaces in at least two parametric directions.

6.7.3 Enumeration and Uniqueness of Function Index Supports

In contrast to the tensor-product B-spline basis where a natural ordered indexing is inherited from the ordering of the univariate B-splines and the tensor-product construction, U-splines do not possess a natural ordering. Instead, a property inherited from the sparsity of the U-spline basis is employed. By construction, each function must have a unique function index support and because each function is the sparsest possible function in the index space, each function must have at least one index corner that it shares with no other function. As a result, the label set L(ϕ_{A}) of a function index support can be defined as the subset of the corner set where

$$L ( {φ}_{A} ) = C ( {φ}_{A} ) \backslash {⋃}_{B \neq A} C ( {φ}_{B} ) . \qquad ( 99 )$$

A unique natural number is then assigned to each label set. Leveraging label sets is particularly important for performant implementations of U-splines where the usage of the full support of a function as a key in a map is impractical.

It should be noted that there is no direct topological connection between the parametric mesh and the natural connectivity of the function control points. The construction of U-spline control meshes will be addressed in a future work.

6.7.4 Determining Function Coefficient Values

Once the function index support of a single function has been determined, the values of the coefficients associated with the indices in the support can be determined. This is accomplished by forming a restricted smoothness constraint matrix for only the coefficients with indices that lie in the function index support. Given a function index support set ϕ, the smoothness constraint matrix S_{ϕ} is formed by removing all columns from the global smoothness matrix S that correspond to indices i∉ϕ. Also, any rows consisting entirely of zeros after this removal step are also removed. If the remaining matrix is empty, then the values of all coefficients will be one (this will only occur for supports with only one entry). Otherwise, the nullspace of the resulting matrix S_{ϕ} will be one-dimensional. A vector of coefficients b_{ϕ} is then obtained by solving the following linear constraint system:

minimize∥b_{ϕ}∥, (100)

subject to S_{ϕ}b_{ϕ}=0, (101)

b_{ϕ}>0. (102)

This problem can be solved as a linear programming problem by a simplex method or similar technique.

6.7.5 Normalization of the Basis

As described previously, each U-spline basis function is defined by a function coefficient vector b_{ϕ}_{_{A}}. For simplicity ϕ_{A} is dropped in favor of A. These vectors represent the coefficients of a non-normalized basis for the U-spline space. To produce a basis that forms a partition of unity, the coefficient vectors must be normalized. The normalized basis is obtained by solving the linear system

$$[ \begin{matrix}{b}_{0} & {b}_{1} & … & {b}_{n}\end{matrix} ] v = [ \begin{matrix}1 \\ 1 \\ ⋮ \\ 1\end{matrix} ] \qquad ( 103 )$$

where n is the total number of basis functions defined over a mesh. The normalized vectors of coefficients are given by v_{A}b_{A}. Because any basis for a U-spline space can be normalized, all coefficient vectors presented hereafter are assumed to be normalized.

Theorem 1. Any Basis for a U-Spline Space can be Normalized to Form a Partition of Unity.

Proof. By definition, a U-spline space must satisfy the continuity conditions at every interface in the mesh. When expressed in Bernstein-Bézier form, each U-spline basis function in the spline space corresponds to a vector of Bernstein coefficients b_{A}. Each of these vectors lies in the nullspace of the global smoothness constraint matrix. The simplest nontrivial member of the spline space is the constant function. This function is represented in Bernstein-Bézier form as a constant vector. By definition, a set of U-spline basis functions {N̅_{A}} for the U-spline space spans the space and is linearly independent. Because the constant vector is a member of the nullspace, there is a unique set of coefficients v_{A} such that

$$\begin{matrix}{\sum }_{A} {v}_{A} {\overline{N}}_{A} = 1. & ( 104 ) \\ & •\end{matrix}$$

6.7.6 an Illustrative Mixed Degree Example in One-Dimension

The U-spline algorithm provides a natural construction for the basis of multi- or mixed-degree splines. The algorithm presented here functions equally well regardless of the polynomial degree as long as the continuity for each interface between elements is less than or equal to the polynomial degree in the direction perpendicular to the interface on both elements adjacent to the interface.

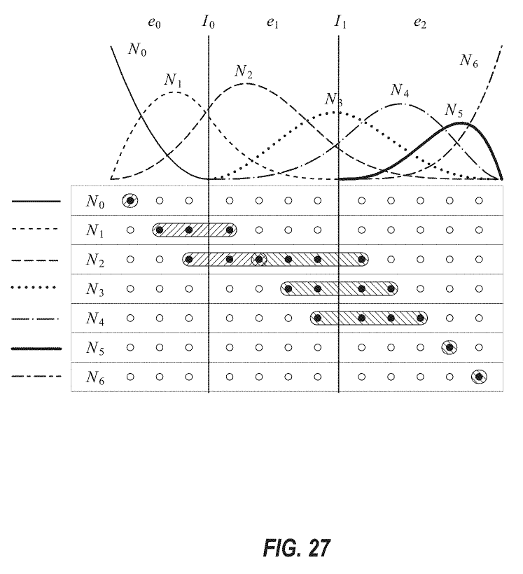

An example of a three element mesh with mixed degree is shown in FIG. 27. FIG. 27 depicts an example of a basis constructed over a mesh of mixed degree. The elements have degree 2, 3, 4, from left to right. The elements have lengths of 3, 4, and 5, respectively. The interfaces have continuity k(I₀)=1 and k(I₁)=2. The functions are plotted with the index support indicated below the plotted functions. Constrained index blocks are marked with shaded regions. The polynomial degrees for the elements are p^{e}^{₀}=2,p^{e}^{₁}=3, and p^{e}^{₂}=4. The element lengths are [symbol] ₑ_{₀}=¼, [symbol] ₑ_{₁}=⅓ and [symbol] ₑ_{₂}= 5/12. The continuity of the interfaces is k(I₀)=1 and k(I₁)=2. The nonzero coefficients of each basis function are indicated by the filled dots below the plots of the figures. The constrained index blocks for each function are also shown.

The global smoothness constraint matrix for this example, as determined by the U-spline algorithm, is

$$S = [ \begin{matrix}0 & 0 & 1 & - 1 & 0 & 0 & 0 & 0 & 0 & 0 & 0 & 0 \\ 0 & - 8 / 3 & 8 / 3 & 3 & - 3 & 0 & 0 & 0 & 0 & 0 & 0 & 0 \\ 0 & 0 & 0 & 0 & 0 & 0 & 1 & - 1 & 0 & 0 & 0 & 0 \\ 0 & 0 & 0 & 0 & 0 & - 15 / 4 & 15 / 4 & 4 & - 4 & 0 & 0 & 0 \\ 0 & 0 & 0 & 0 & 75 / 8 & - 75 / 4 & 75 / 8 & - 12 & 24 & - 12 & 0 & 0\end{matrix} ] . \qquad ( 105 )$$

The resulting coefficient vectors which define the U-spline basis functions can be arranged as the rows of a matrix commonly called the extraction operator:

$$C = [ \begin{matrix}1 & 0 & 0 & 0 & 0 & 0 & 0 & 0 & 0 & 0 & 0 & 0 \\ 0 & 1 & 8 / 17 & 8 / 17 & 0 & 0 & 0 & 0 & 0 & 0 & 0 & 0 \\ 0 & 0 & 9 / 17 & 9 / 17 & 1 & 155 / 331 & 75 / 331 & 75 / 331 & 0 & 0 & 0 & 0 \\ 0 & 0 & 0 & 0 & 0 & 176 / 331 & 19360 / 38727 & 19360 / 38727 & 55 / 117 & 0 & 0 & 0 \\ 0 & 0 & 0 & 0 & 0 & 0 & 32 / 117 & 32 / 117 & 62 / 117 & 1 & 0 & 0 \\ 0 & 0 & 0 & 0 & 0 & 0 & 0 & 0 & 0 & 0 & 1 & 0 \\ 0 & 0 & 0 & 0 & 0 & 0 & 0 & 0 & 0 & 0 & 0 & 1\end{matrix} ] . \qquad ( 106 )$$

It can be verified that the extraction operator satisfies SC^{T}=0. The extraction operator can be used to generate the spline basis in terms of the Bernstein basis over the mesh:

$$[ \begin{matrix}1 & 0 & 0 & 0 & 0 & 0 & 0 & 0 & 0 & 0 & 0 & 0 \\ 0 & 1 & 8 / 17 & 8 / 17 & 0 & 0 & 0 & 0 & 0 & 0 & 0 & 0 \\ 0 & 0 & 9 / 17 & 9 / 17 & 1 & 155 / 331 & 75 / 331 & 75 / 331 & 0 & 0 & 0 & 0 \\ 0 & 0 & 0 & 0 & 0 & 176 / 331 & 19360 / 38727 & 19360 / 38727 & 55 / 117 & 0 & 0 & 0 \\ 0 & 0 & 0 & 0 & 0 & 0 & 32 / 117 & 32 / 117 & 62 / 117 & 1 & 0 & 0 \\ 0 & 0 & 0 & 0 & 0 & 0 & 0 & 0 & 0 & 0 & 1 & 0 \\ 0 & 0 & 0 & 0 & 0 & 0 & 0 & 0 & 0 & 0 & 0 & 1\end{matrix} ] {B}^{M} = [ \begin{matrix}{N}_{0} \\ {N}_{1} \\ {N}_{2} \\ {N}_{3} \\ {N}_{4} \\ {N}_{5} \\ {N}_{6}\end{matrix} ] \qquad ( 107 )$$

where the vector of Bernstein basis functions over the mesh is

$${B}^{M} = [ \frac{{B}_{{e }_{0}}}{\frac{{B}_{{e }_{1}}}{{B}_{{e }_{2}}}} ] \qquad ( 108 )$$

and the element Bernstein basis vectors are

Bₑ_{₀}^{T}=[Bₑ_{₀}_{,0}²Bₑ_{₀}_{,1}²Bₑ_{₀}_{,2}²], (109)

Bₑ_{₁}^{T}=[Bₑ_{₁}_{,0}³Bₑ_{₁}_{,1}³Bₑ_{₁}_{,2}³], (110)

Bₑ_{₂}^{T}=[Bₑ_{₂}_{,0}⁴Bₑ_{₂}_{,1}⁴Bₑ_{₂}_{,2}⁴], (109)

6.7.7 Construction of Multivariate U-Splines

The U-spline algorithm for multivariate meshes operates on a similar principle of constructing function supports from sets of compatible constrained index blocks with accom-modations made for the structure of the multivariate mesh. Whereas only a perpendicular direction exists for each interface in a one-dimensional mesh, higher dimensional meshes have directions that lie parallel to the interface which must be properly handled during block transfer across interfaces. These block transfer rules have been presented in detail for two-dimensional meshes in Section 6.5. Analogous rules can easily be defined for three-dimensional meshes (or higher dimensions).

It should be noted that there are actually several distinct approaches to computing function index supports that could be considered. The first, which has been presented in this work, uses the rules given here to construct constrained index blocks and then to find minimally supported collections of constrained index blocks by flooding in order to generate the function index supports. Second, it is also possible to use the rules for constrained index block construction given here to compute constrained index blocks and then find the minimal combination by searching for a minimal contiguous set of constrained index blocks that satisfy the continuity constraints. This is computationally more expensive. Third, it is possible to compute the constrained index blocks directly from the constraint matrix without leveraging the principles given here and then computing a minimal set of these blocks. This is more efficient than the generic nullspace problem but is the least efficient method given here. All three methods leverage the locality of constrained index blocks to improve over the global method.

6.7.8 Advanced Considerations

In regions of the mesh where transitions in the properties assigned to mesh features occur in close proximity, additional complexities arise. In this work, transitions of scale (T-junctions), degree, and continuity are considered. Nonpolynomial Bernstein-like bases can introduce a fourth class of transitions that is functionally similar to the case of degree transitions.

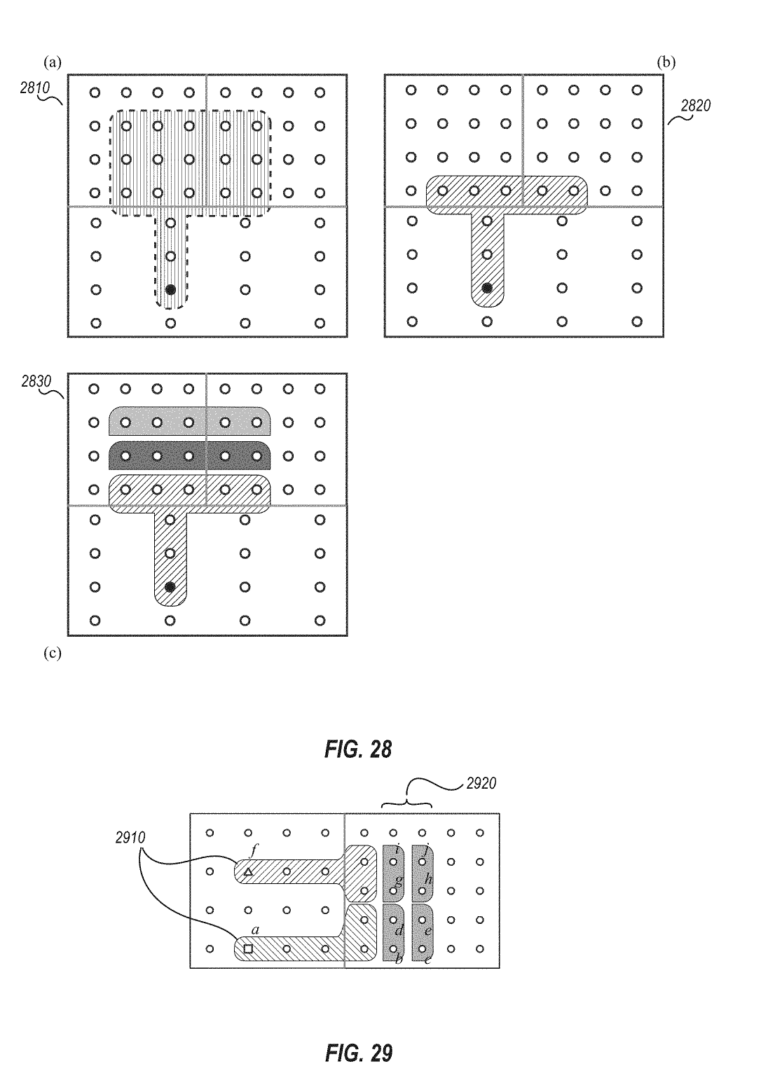

The algorithms for the construction of constrained index blocks presented to this point have illustrated minimal sets of Bernstein indices required by simple interface continuity constraints. In some cases, the coefficients that lie beyond the minimal set of a single constraint must be considered. One example of this is shown in FIG. 28. FIG. 28 depicts indices of coefficients constrained by C² interfaces and a T-junction (a). Constrained index block generated by the index associated with the filled dot (b). Latent extensions to the constrained index block are shown in gray (c). Part (a) 2810 of FIG. 28 shows the indices of all the Bernstein coefficients that are coupled by the C² constraint. Part (b) 2820 shows the constrained index block created from the index indicated by the filled dot. The continuity constraint also induces latent constraints on coefficients with indices within a distance 2 of the interface. Latent extentions to the constrained index block are illustrated in part (c) 2830. The coefficients with indices inside the gray areas are constrained by their proximity to the interface. If any one of the coefficients in one of the gray regions is nonzero then all of the coefficients in that region must also be nonzero. If one attempted to set one of the coefficients to be nonzero without the others, it would be impossible to satisfy the continuity constraints. This follows from the fact that multiple basis functions from the small elements are required to represent a single function from the large element.

A similar situation occurs at the interface between elements of differing polynomial degree. This actually holds for elements with differing numbers of basis functions having a nontrivial intersection of their trace spaces such as QEC Bernstein-like bases containing polynomials of some order. In this situation, more than one function is required to represent an adjacent function. An example is shown in FIG. 29. FIG. 29 depicts selected examples of constrained index blocks for two elements of different polynomial degrees and the latent constrained index blocks (gray). In FIG. 29, the constrained index blocks associated with indices on the lower degree (cubic) side are shown by the hatched area 2910. The index locations are labeled. If the coefficient associated with the index iₐ is nonzero and the coefficient associated with the index i_{b} is also nonzero, then the coefficient associated with i_{d} must also be nonzero. The same restriction applies to each pair of indices surrounded by a gray block 2920. Another case is shown for the index if.

In the simple examples considered heretofore, these latent constraints have not been considered but they are required for more complex examples, especially those involving adjacent transitions in perpendicular directions.

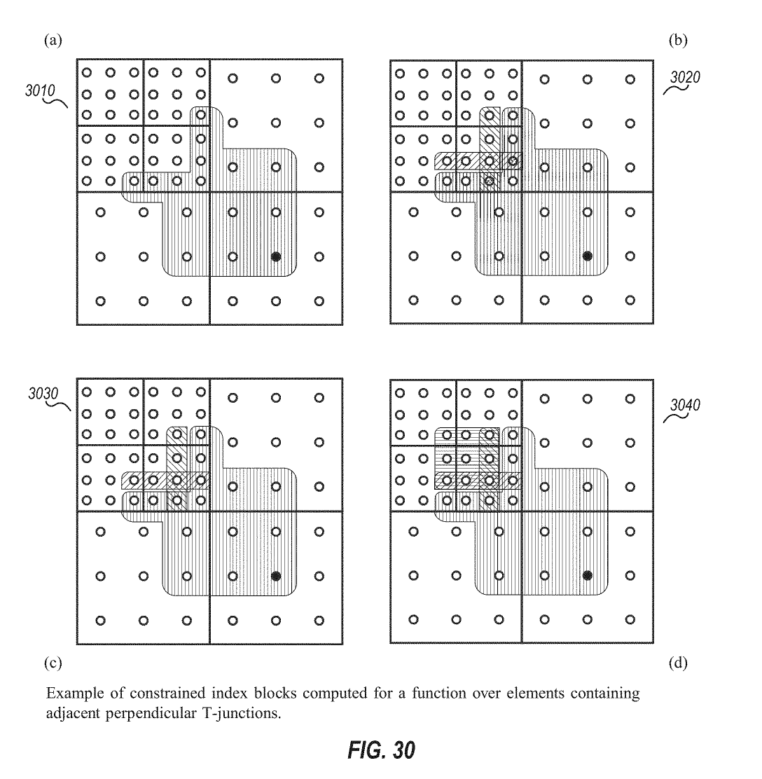

Consider the mesh of biquadratic elements shown in FIG. 30. Part (a) 3010 of the figure shows the constrained index block computed from the seed index marked with a filled dot without considering the latent constrained index blocks. The latent blocks are shown in part (b) 3020 with the indices at which they intersect the previously computed support marked with filled dots. In part (c) 3030 the constrained index block has been expanded to include the relevant latent regions. The function index support computation is then continued to produce the upper left block shown in part (d) 3040.

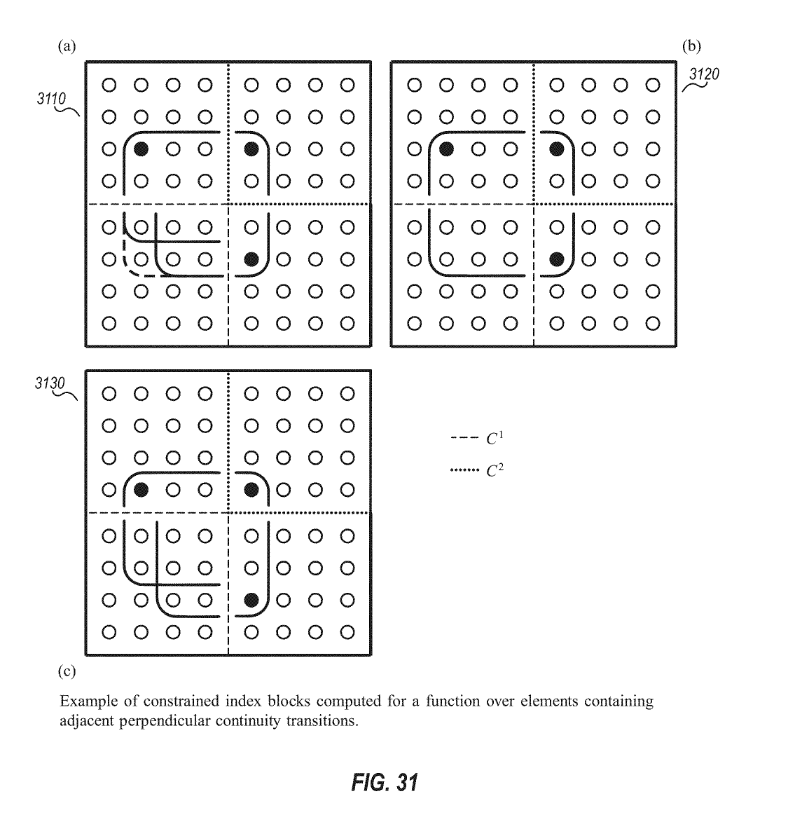

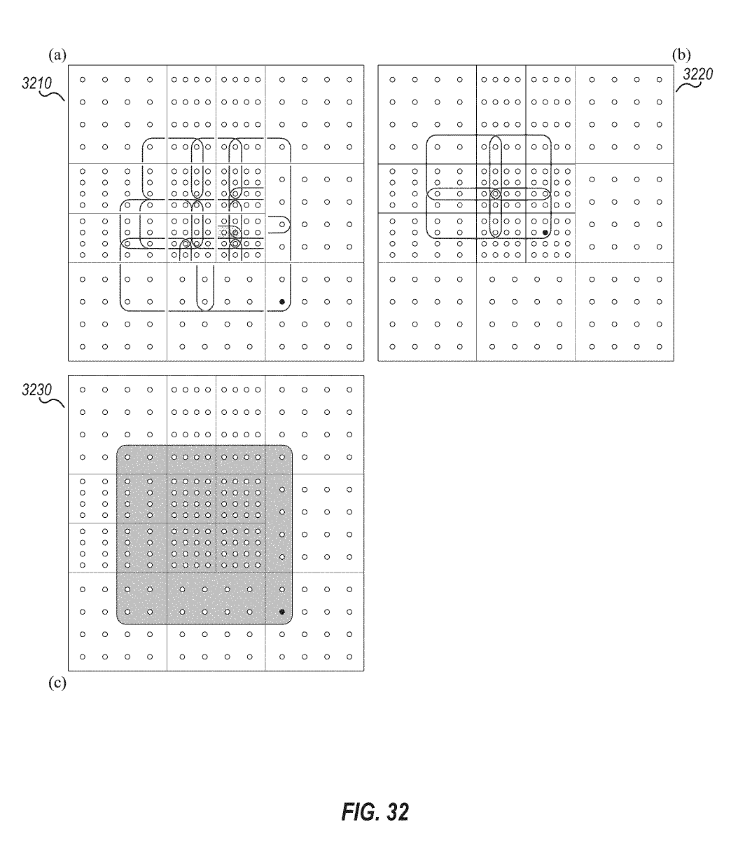

A similar situation occurs for perpendicular adjacent continuity transitions. A simple mesh containing edges with continuity C¹ and C² is shown in FIG. 31. The edges with C¹ continuity are marked with dashed lines while the edges with C² continuity are marked with dotted lines. All elements have been assigned a bicubic polynomial basis. Part (a) 3110 of FIG. 31 shows the constrained index block computed from any of the indices having a filled marker. The index blocks that make up the constrained index block are outlined with solid lines. The latent constrained index block due to the continuity transition is indicated by the dashed line. The constraint system assembled for the coefficients inside the index blocks bounded by the solid lines cannot satisfy the continuity constraints. In order to successfully compute a basis function, the latent block must be added to the support as shown in part (b) 3120 of FIG. 31. Contrast the constrained index block shown in part (b) where the index support is square with the constrained index block shown in part (c) 3130 where the index support is not square. The seeds of the block shown in part (c) are positioned so that the support of the constrained index block extends beyond the support of any latent blocks.

One last example is presented that illustrates the implications of the function support requirement given in Equation (98). FIG. 32 depicts an example of a cubic function built from the index marked with a black dot to satisfy the support requirements given in Equations (95) to (97) in part (a). Part (b) shows the additional index blocks required by activation of the latent block marked with a filled region in part (a) and subsequently satisfying (98). The full final support is shown in part (c). Part (a) 3210 of FIG. 32 shows the function support that satisfies the function support requirements given in Equations (95) to (97) produced by using the index marked with a black filled dot as the seed. The shaded region indicates a portion of a latent constrained index block. Adding this block and satisfying (98) requires the addition of the index blocks shown in part (b) 3220 of FIG. 32 to the function support. The full final support is shown in part (c) 3230.

### 6.8 Examples of Multivariate Basis Construction

Several examples that illustrate fundamental differences between the U-spline approach and previously developed technologies are now presented.

To begin, an example of a single U-spline basis function is shown to demonstrate several of the unique features of the construction. Part (a) 3310 of FIG. 33 shows a Bézier mesh. Each element has a basis of polynomial degree 3 in each direction. Each internal interface has C² continuity. The nonzero indices associated with this function are shown with filled circles. The shade of the circle indicates the relative value of the associated coefficient. Part (b) 3320 shows a contour plot of the function. Part (c) 3330 shows a three-dimensional surface produced by setting the z value of the control point associated with the function to 1. This example was chosen to highlight a significant difference between U-spline basis functions and many other splines such as B-splines, T-splines, and LR-splines among others. Most splines rely on tensor-product bases which are square. The U-spline construction is clearly capable of producing bases that are not generated by a tensor product.

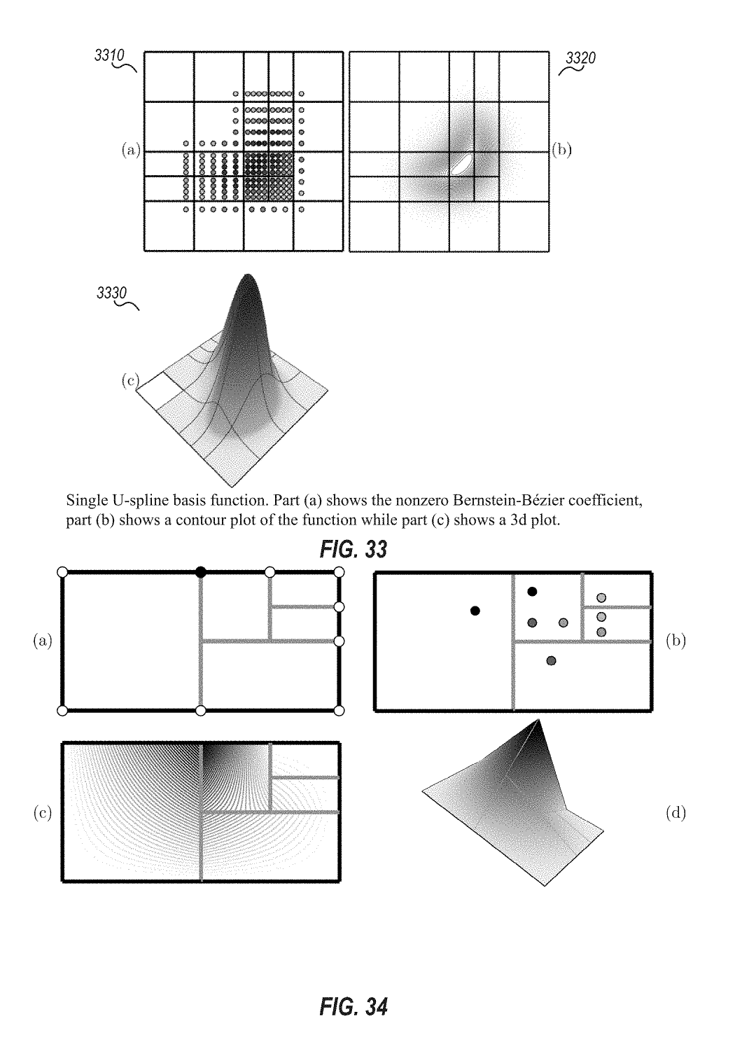

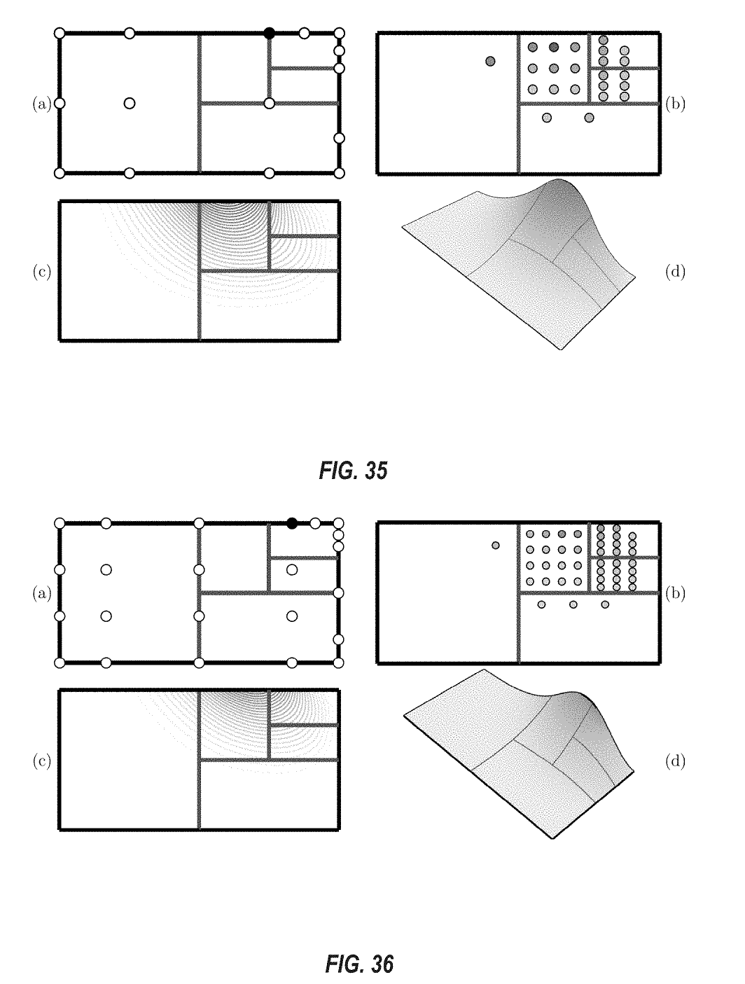

A Bézier mesh consisting of nested T-junctions is considered next. Three instances of the same mesh are shown in FIGS. 34 to 36. FIG. 34 depicts an example basis function from a Bézier mesh containing nested T-junctions. Each element has a basis of polynomial degree 1. The control points of all functions are shown in part (a) with the control point of one function marked. Parts (b-d) show the values of the Bernstein coefficients, a contour plot, and a three dimensional plot of the function, respectively. In FIG. 34, each element is assigned a bilinear basis and each edge is C°. FIG. 35 depicts an example basis function from a mesh containing nested T-junctions. Each element has a basis of polynomial degree 2. The control points of all functions are shown in part (a) with the control point of one function marked. Parts (b-d) show the values of the Bernstein coefficients, a contour plot, and a three dimensional plot of the function, respectively. FIG. 36 depicts an example basis function from a mesh containing nested T-junctions. Each element has a basis of polynomial degree 3. The control points of all functions are shown in part (a) with the control point of one function marked. Parts (b-d) show the values of the Bernstein coefficients, a contour plot, and a three dimensional plot of the function, respectively. In FIGS. 35 and 36, the elements have biquadratic and bicubic bases, respectively. The interfaces of the mesh with biquadratic elements are C′ while the mesh with bicubic elements has C² interfaces.

The control points and boundaries of the elements are shown in part (a) of each figure. It can be seen from the element boundaries that the basis is capable of representing a linear map. The basis function associated with the control point marked with a filled black circle is shown in parts (b-d) of each figure. Part (b) shows the indices of the nonzero Bernstein coefficients, shaded by the relative amplitude. The index support of each function possesses a notch in the upper-right hand corner of the support that would not be present in a tensor-product construction. The contour plot in part (c) of each figure exhibits an indentation due to the notch in the index support. This is most apparent in the linear case shown in FIG. 34. Again each function clearly cannot be produced by a tensor product. Part (d) of each figure shows the surface produced by elevating just the control point associated with the highlighted basis function.

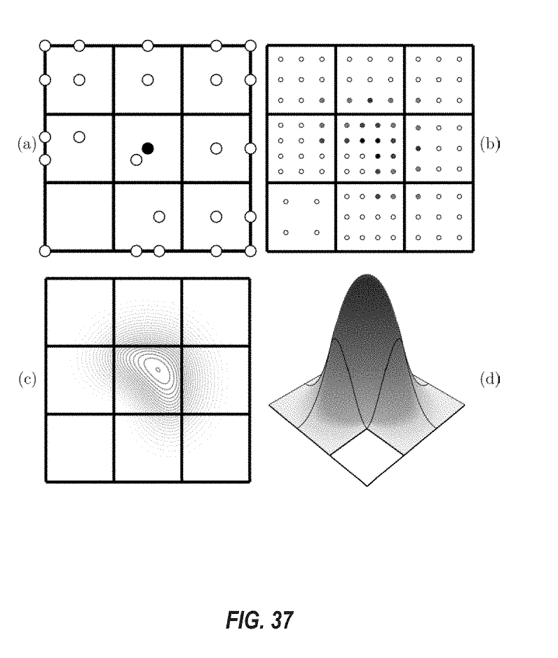

An example to illustrate one potential application of the ability to mix elements of differing polynomial degrees is now given. FIG. 37 depicts an example of a single basis function defined over a mesh of mixed polynomial degree. The control points producing a linear parameterization are shown in part (a). The control point corresponding to the highlighted function is highlighted. The index support and coefficients (b), contour plot (c), and three-dimensional surface (d) of the function are shown. The polynomial degree of each element in the mesh shown in part (b) of FIG. 37 can be determined from the number of dots drawn on each element. The degree in each direction is one less than the number of dots. It can be seen that the mesh has one bilinear element, 5 biquadratic elements, one cubic element, one element of degree (2,3) and one of degree (3,2). All interfaces are C¹. The bilinear element is joined smoothly to the adjacent elements and so were it not for the increase in degree in the elements immediately adjacent to the bilinear element, the linear functions would impact functions defined over elements not immediately adjacent to the lower degree element. The introduction of the cubic region isolates the bilinear element from all other elements in the mesh other than those that are immediately adjacent. This is a generally useful technique to isolate local features.

All of the control points that define a linearly parameterized geometry for the basis are shown in part (a) of FIG. 37. The basis function highlighted corresponds to the control point marked with a filled dot. The nonzero coefficients indicated by filled dots in part (b) of the figure form an L. This pattern is reflected in the basis function. The contour plot shown in part (c) and the three-dimensional surface plot of the function in part (d) both clearly exhibit an L shape. This is another instance in which the U-spline construction produces functions that cannot be produced by other methods. It should also be noted that the function is formed from a mixture of smoothly joined quadratic and cubic basis functions.

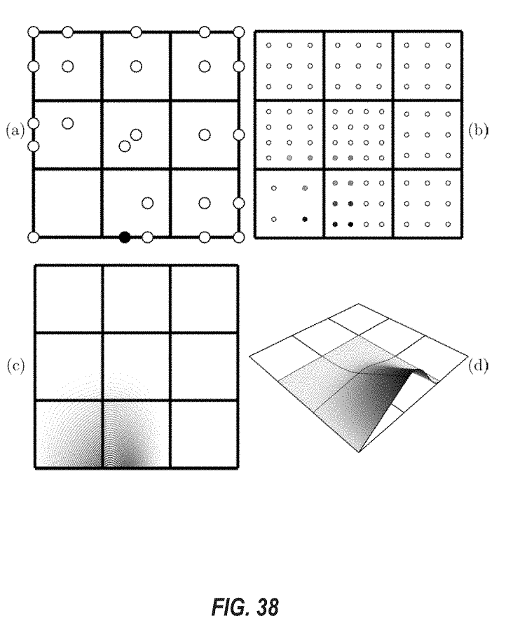

Another function from the same basis is shown in FIG. 38. FIG. 38 depicts an example of a single basis function defined over a mesh of mixed polynomial degree. The control points producing a linear parameterization are shown in part (a). The control point corresponding to the highlighted function is highlighted. The index support and coefficients (b), contour plot (c), and three-dimensional surface (d) of the function are shown. The highlighted function corresponding to the filled dot in part (a) is chosen to illustrate the smooth transition between the bilinear and higher degree elements in the U-spline.

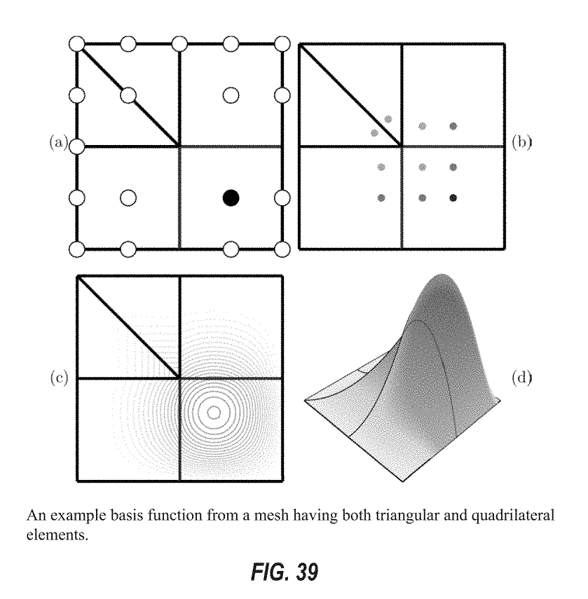

FIG. 39 shows a simple mesh consisting of both triangular and quadrilateral elements. All elements have polynomial degree 2. The edges of the triangle are C⁰ while all other edges are C¹. The highlighted function spans both element types. The C¹ transitions on all edges not shared with triangles are apparent.

### 6.9 Storage and Representation of U-Splines and Data

As described previously, design and analysis representations rely on the definition of a basis. Typically, design tools have relied on splines (B-splines/NURBS or T-splines) in order to provide the required level of smoothness and surface quality and analysis tools have primarily relied on linear shape functions to provide the required mathematical properties. The U-spline construction represents an improved basis that meets the demand of both design and analysis. Objects in both design and analysis can be represented as sums of basis functions multiplied by coefficients. The representation of shape in CAD, changes from Equation (1) to

$$x ( s , t ) = {\sum }_{A} {P}_{A} {N}_{A} ( s , t ) \qquad ( 112 )$$

and the representation of the solution in analysis changes from Equation (2) to

$$u = {\sum }_{A} {d}_{A} {N}_{A} . \qquad ( 113 )$$

In both cases, the basis is now the U-spline basis rather than a spline basis and shape functions. This provides many benefits over techniques that separate the definition of the geometry from the analysis.

Practical applications of the U-spline basis require efficient methods to store the basis functions and data associated with the basis functions. In order to represent a U-spline, the mesh must be stored along with the parametric data specifying edge lengths and the order of continuity of every interface. Enough data to specify the basis on each element must also be saved. For cuboidal elements with polynomial bases, it is sufficient to store the polynomial degree in each parametric direction. More general Bernstein-like bases require additional data. For simplicial elements, just a single polynomial degree is sufficient.

The primary requirement for use of a U-spline is a persistent indexing of the basis functions so that arrays of properties may be associated with the proper basis function. This is accomplished by pairing an integer index with at least one Bernstein index that is unique to the spline basis function. This unique index is sufficient to rebuild the function index support by using it as a seed. Other storage strategies are also possible; it may be beneficial to store all of the corners unique to a given function or all of the elements in the function support. Regardless of the extra data that may also stored, one unique corner must be stored. Any additional data is effectively prioritizing computation over storage as any properties of the basis may be computed from the unique corner using the corner as a seed for the U-spline construction.

It may also be advantageous to store the representation of the basis. The simplest approach is to store a map for each basis function that returns the coefficient value associated with each index in the function index support. An optimal approach is to store pointers to the unique mathematical expressions that, when evaluated at a specific parametric location, evaluate the basis. In this way, the redundancy in uniform mesh regions can be significantly reduced.

When using U-splines in computations, it is necessary to know which functions are defined on each element and what the values of the coefficients of the local basis that represent each function are. This data can be stored explicitly, but again, by storing pointers to the unique expressions used in the basis, all information necessary to use the basis in computations can be stored in an optimally compressed format.

### 6.10 Benefits and Applications Enabled by U-Splines

6.10.1 U-Spline Shape Representations

U-splines are an efficient and robust representation of shape due to their unprece-dented flexibility and mathematical precision. This is especially true in the context of CAD data. U-splines possess the precision of NURBS, the current CAD standard, with far more capability to represent complex geometry and topology in a watertight, mathematically rigorous fashion. No superfluous design parameters are required in U-spline CAD due to the ability to perform geometrically exact element subdivision, change the degree of collections of faces, and change the smoothness of edges.

6.10.2 U-Spline CAE Technologies

U-splines can be used directly in CAE applications because the underlying basis is analysis-suitable, as described in Table 1. The unique properties of the U-spline basis, such as smoothness, enable more robust, accurate, and efficient simulation results than traditional approaches to CAE, such is finite element analysis (FEA). Introducing exact U-spline geometry into simulation also improves simulation behavior since a faceted approximation is replaced by the smooth exact CAD geometry.

6.10.3 CAD-CAE Integration

The integration of U-splines into existing CAD and CAE software, as well as the creation of new U-spline-based CAD-CAE software, has the potential to substantially address and eliminate the following serious inefficiencies:
Preparing an entire automobile for a crash simulation costs millions of dollars and many weeks in manual labor to convert the CAD data and prepare the simulation mesh for analysis, and results in the CAE and CAD data getting out of sync.
In the aerospace, defense, and automotive industries, nearly 90% of simulation time is spent converting and preparing the CAD geometry.
In smaller firms that don't employ simulation experts, products are commonly over-engineered or improperly engineered because of the complexity and limitations of getting data into CAE software, which prevents its proper use in the design process.
Even expert CAE engineers run into limitations when accuracy is lost as they convert exact CAD data to faceted CAE meshes; this especially limits the possibility of exploiting new manufacturing processes like generative design and additive manufacturing.

The result of these inefficiences is that hundreds of millions of dollars are wasted annually across key global industries like automotive, aerospace, and defense due to the difficulty in transitioning CAD data to CAE software to run simulations. Attempts to eliminate this data translation problem in the past have resulted in limited simulation capability or created an inferior process.

In contrast, U-splines have an underlying mathematical formulation which makes it possible to use a U-spline basis for both design and simulation, resulting in a completely integrated IGA approach.

6.10.4 Topology Optimization, Shape Optimization, and Generative Design

Structural design based on topology and shape optimization and other generative design techniques are becoming increasingly important since they are capable of producing optimal, lightweight structures that can be manufactured using three-dimensional printing techniques. However, the resulting designs are often complex organic shapes represented as a dense triangulation that is not suitable for CAD. The process of turning the triangulation into a CAD object is a manual, error-prone, labor intensive process which limits the practical application of the approach. U-splines have the potential to significantly improve this situation because they are the first CAD representation which is flexible enough to be used directly in the optimization framework and as the output CAD format. As a result, all data translation steps can be eliminated and the output U-spline CAD can be either converted back into a traditional CAD format based on NURBS or taken directly as the CAD object.

The small number of parameters required to represent smooth shapes using U-splines is also advantageous in optimzation problems as it has the potential to dramatically reduce the size of the system. It is also guaranteed that the smoothness of the input shape will be preserved.

6.10.5 Volumetric Data Representation

There are many applications in which data needs to be representated throughout the volume rather than just on the surface or boundary. U-splines provide an efficient representation of the internal region of an object and thus enable true volumetric representation of data.

New additive manufacturing techniques make it possible to design and manufacture complex parts with non-uniform material composition. Traditional CAD BREPS can only describe the outside envelope of a part and assume uniform material composition. Techniques such as BREP slicing can be used to extend the amount of internal material variance possible within a BREP solid, but still place strict limitations on how detailed the material layout can be. In contrast to BREP CAD, the precise mathematical definition of U-splines can be extended to three-dimensional volumetric representations which can then be tailored through local adaptivity to capture complex material composition in a precise manner.

### 6.11 Exemplary Computing Environment

The methods, systems, data structures, and computer program products as described herein may be produced and may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

### 6.12 Conclusion

Described herein are embodiments related to the construction, use and storage of U-splines. The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for constructing a U-spline basis over a mesh, the system comprising:
one or more computer processors; and
computer readable memory having stored therein computer-executable instructions which, when executed upon the one or more processors, configure the system to perform a method comprising:
accessing data representing a mesh, the mesh comprising a plurality of cuboidal or simplicial elements, connectivity between adjacent elements, parametric data assigned to each edge of every element including parametric length and direction within a local coordinate system of the every element, specification of a desired level of continuity on each interface between adjacent elements, and data that defines a Bernstein-like basis on each element;
determining a set of basis functions for the mesh by, for each seed Bernstein index of the mesh:
a) constructing a function index support that has the each seed as a corner;
b) determining whether a function with a same function index support has already been created; and
c) when a function with the same index support has not already been created, determining coefficient values for the function;
normalizing the determined set of functions such that for each index in the mesh, a sum of all nonzero coefficients sharing the each index for any functions in the mesh is equal to one; and
outputting the determined set of basis functions for subsequent further use in design or analysis.

2. The system of claim 1, wherein constructing the function index support that has the each seed as a corner comprises:
determining a constrained index block having the seed index as a corner;
marking the block;
marking any unmarked constrained index blocks sharing corners and having minimal overlap with previously marked blocks;
when the seed index is not a corner of the function index support, then continuing to the next seed index.

3. The system of claim 1, wherein determining coefficient values for the function comprises:
forming a smoothness constraint matrix for coefficients corresponding to the indices in the function index support; and
determining a vector that represents a nullspace of the constraint matrix.

4. The system of claim 1, wherein the accessed mesh is a mesh generated by computer-aided design (CAD) or a mesh generated for finite element analysis (FEA).

5. The system of claim 1, wherein the output set of basis functions are provided as input to one of computer-aided design (CAD) or computer-aided engineering (CAE).

6. The system of claim 1, wherein the Berstein-like basis includes trigonometric functions.

7. The system of claim 1, wherein the Berstein-like basis includes exponential functions.

8. The system of claim 1, wherein the accessed mesh comprises mixed elements.

9. The system of claim 1, wherein there are no restrictions on the placement of T-junctions in the accessed mesh.

10. A method for constructing a U-spline basis over a mesh, the method comprising:
accessing data representing a mesh, the mesh comprising a plurality of cuboidal or simplicial elements, connectivity between adjacent elements, parametric data assigned to each edge of every element including parametric length and direction within a local coordinate system of the every element, specification of a desired level of continuity on each interface between adjacent elements, and data that defines a Bernstein-like basis on each element;
determining a set of basis functions for the mesh by, for each seed Bernstein index of the mesh:
a) constructing a function index support that has the each seed as a corner;
b) determining whether a function with a same function index support has already been created; and
c) when a function with the same index support has not already been created, determining coefficient values for the function;
normalizing the determined set of functions such that for each index in the mesh, a sum of all nonzero coefficients sharing the each index for any functions in the mesh is equal to one; and
outputting the determined set of basis functions for subsequent further use in design or analysis.

11. The method of claim 10, wherein constructing the function index support that has the each seed as a corner comprises:
determining a constrained index block having the seed index as a corner;
marking the block;
marking any unmarked constrained index blocks sharing corners and having minimal overlap with previously marked blocks;
when the seed index is not a corner of the function index support, then continuing to the next seed index.

12. The method of claim 10, wherein determining coefficient values for the function comprises:
forming a smoothness constraint matrix for coefficients corresponding to the indices in the function index support; and
determining a vector that represents a nullspace of the constraint matrix.

13. The method of claim 10, wherein the accessed mesh is a mesh generated by computer-aided design (CAD) or a mesh generated for finite element analysis (FEA).

14. The method of claim 10, wherein the output set of basis functions are provided as input to one of computer-aided design (CAD) or computer-aided engineering (CAE).

15. The method of claim 10, wherein the Berstein-like basis includes trigonometric functions or exponential functions.

16. The method of claim 10, wherein the accessed mesh comprises mixed elements.

17. The method of claim 10, wherein there are no restrictions on the placement of T-junctions in the accessed mesh.

18. A computer program product for constructing a U-spline basis over a mesh, the computer program product comprising one or more computer-readable storage devices having stored therein computer-executable instructions which, when executed within a computing system, configure the system to perform a method comprising:
accessing data representing a mesh, the mesh comprising a plurality of cuboidal or simplicial elements, connectivity between adjacent elements, parametric data assigned to each edge of every element including parametric length and direction within a local coordinate system of the every element, specification of a desired level of continuity on each interface between adjacent elements, and data that defines a Bernstein-like basis on each element;
determining a set of basis functions for the mesh by, for each seed Bernstein index of the mesh:
a) constructing a function index support that has the each seed as a corner;
b) determining whether a function with a same function index support has already been created; and
c) when a function with the same index support has not already been created, determining coefficient values for the function;
normalizing the determined set of functions such that for each index in the mesh, a sum of all nonzero coefficients sharing the each index for any functions in the mesh is equal to one; and
outputting the determined set of basis functions for subsequent further use in design or analysis.

19. The computer program product of claim 1, wherein constructing the function index support that has the each seed as a corner comprises:
determining a constrained index block having the seed index as a corner;
marking the block;
marking any unmarked constrained index blocks sharing corners and having minimal overlap with previously marked blocks;
when the seed index is not a corner of the function index support, then continuing to the next seed index.

20. The computer program product of claim 1, wherein determining coefficient values for the function comprises:
forming a smoothness constraint matrix for coefficients corresponding to the indices in the function index support; and
determining a vector that represents a nullspace of the constraint matrix.
